(19) United States
(12) Patent Application Publication
(10) Pub. No.: US 2018/0013663 A1
(43) Pub. Date: Jan. 11, 2018

(54) COMMUNICATION METHOD, COMMUNICATION SYSTEM, AND COMMUNICATION APPARATUS

(71) Applicant: FUJITSU LIMITED, Kawasaki-shi (JP)

(72) Inventor: Toshihiko Kurita, Kawasaki (JP)

(73) Assignee: FUJITSU LIMITED, Kawasaki-shi (JP)

(21) Appl. No.: 15/642,293

(22) Filed: Jul. 5, 2017

(30) Foreign Application Priority Data
Jul. 7, 2016 (JP) 2016-135370
Jan. 23, 2017 (JP) 2017-009712

(51) Int. Cl. H04L 12/725; H04L 12/813; H04L 12/24; H04L 29/08; H04B 7/14

(52) U.S. Cl. CPC H04L 45/306; H04L 67/10; H04B 7/14; H04L 41/0893; H04L 47/20

(57) ABSTRACT

A communication method executed by a communication system, the communication method includes determining, by a first node that requests to execute an application, a policy for selecting a node to execute the application from the plurality of relay nodes based on an amount of an output data which is an execution result of the application and an amount of an input data for executing the application; transmitting a request message including identification information indicating the policy and requesting to execute the application via the path; receiving, by a third node, the request message; acquiring data for executing the application from a second node, when it is determined that the third node is able to execute the application based on the identification information; executing the application using at least the acquired data; and transmitting a response message including the execution result of the application to the first node.

### CROSS-REFERENCE TO RELATED APPLICATION

This application is based upon and claims the benefit of priority of the prior Japanese Patent Application No. 2016-135370, filed on Jul. 7, 2016, and the prior Japanese Patent Application No. 2017-009712, filed on Jan. 23, 2017, the entire contents of which are incorporated herein by reference.

### FIELD

The embodiments discussed herein are related to a communication method, a communication system, and a communication apparatus.

### BACKGROUND

New network architectures called information-centric networking (ICN) in which communication and acquisition can be performed by designating content with names are noticed. Further, for application execution in such networking, a scheme called named function networking (NFN) is known. In the NFN, nodes of application execution locations in a network are decided. Then, requests for executing applications are sent from request nodes to the decided nodes. The decided nodes acquire applications and data designated by the requests from networks, execute the applications, and return execution results to requesting nodes.

In relation to a message delivery method of delivering messages exchanged between software distributed and disposed via a network, there is known a technology capable of realizing an efficient intelligent distribution environment (for example, Japanese Laid-open Patent Publication No. 11-175421). In a case in which messages exchanged between software distributed and disposed are transmitted via a network, a service list defined with link of a pair of data between delivery destination information for a message and process information for designating the message is added to the message. A service list portion for which a process is ended by software of a delivery destination is deleted. Further, a service list can be rewritten as appropriate. In addition, the message to which the service list is added is delivered from software to software.

In a case in which request distribution is performed in response to file transmission requests from clients using a plurality of servers, there is known a technology capable of performing appropriate distribution (for example, Japanese Laid-open Patent Publication No. 2001-243142). A process determination unit compares indispensable times for responses obtained by “RTs1, c (FS)<RTs1, c (MSr)+RTc, s2 (MSq)+RTs2, c (FS)”. RTa, b (L) is a predicted transmission time taken in a case in which a file with a size L is transmitted from a terminal a to a terminal b. FS is the size of a file to be transmitted and MSr is the size of a redirection message. MSq is a file size of a request transmitted again to another server by a client.

Further, for a communication method of a network node for IP routing compatibility, there is known the following technology (for example, Japanese National Publication of International Patent Application 2016-502343). The method includes a step of generating a packet that includes a content name including first information indicating the position of content and second information identifying the content and a step of transmitting the generated packet. Thus, a gateway that converts a packet format may not be installed between an IP network and a content-centered network. Then, the packet format can be used without converting a general packet format for IP.

In the above-described NFN, typically, a first NFN node (or a node in the vicinity of a request node) on a path through which a request message is transmitted on a network executes an application as an application executable node. Therefore, the following problem occurs, for example, in a case in which an application, such as an image analysis application, in which input data (image data) of an application or to an application is larger than output data (analysis result) of an application is executed.

There is a problem that transmission delay of the application or the data increases since an application or data has to be transmitted from a distant node to an application executable node, and thus a response time (a time until a response is received after a user gives an application execution request) is late. In view of the above-mentioned circumstances, a response of an application execution result may be quickened by decreasing data transmission delay.

### SUMMARY

According to an aspect of the invention, a communication method executed by a communication system including a first node that requests to execute an application, a second node that stores data for executing the application, and a plurality of relay nodes coupled to a path between the first and second nodes, the communication method includes determining, by the first node, a policy for selecting a node to execute the application from the plurality of relay nodes based on an amount of an output data which is an execution result of the application and an amount of an input data for executing the application; transmitting a request message including identification information indicating the policy and requesting to execute the application via the path; receiving, by a third node among the plurality of relay nodes, the request message; acquiring the data from the second node, when it is determined that the third node is able to execute the application based on the identification information; executing the application using at least the acquired data; and transmitting a response message including the execution result of the application to the first node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating characteristics of ICN;

FIG. 2 is a diagram illustrating a basic model of NFN;

FIG. 3 is a diagram illustrating control of application execution in NFN;

FIG. 4 is an explanatory diagram illustrating a communication system performing application execution according to a first embodiment (an explanatory diagram illustrating a first operation example of the first embodiment);

FIG. 5 is an explanatory diagram illustrating a communication system performing an application execution according to a second embodiment;

FIG. 6 is a diagram illustrating a configuration example of the communication system performing the application execution according to the first or second embodiment;

FIG. 7 is a diagram illustrating a hardware configuration example of a communication apparatus included in a node;

FIGS. 8A and 8B are diagrams illustrating format examples of a request message and response messages communicated in the communication system performing the application execution according to the first or second embodiment;

FIG. 9 is a diagram illustrating a configuration example of a PL setting table;

FIG. 10 is a flowchart illustrating an example of a message transmission process of a relay node in the communication system performing the application execution according to the first or second embodiment;

FIG. 11 is a diagram illustrating a sequence of a first operation example according to the first embodiment;

FIG. 12 is an explanatory diagram illustrating a second operation example according to the first embodiment;

FIG. 13 is a diagram illustrating a sequence of a second operation example according to the first embodiment;

FIG. 14 is an explanatory diagram illustrating a third operation example according to the first embodiment;

FIG. 15 is a diagram illustrating a sequence of the third operation example according to the first embodiment;

FIG. 16 is an explanatory diagram illustrating a fourth operation example according to the first embodiment;

FIG. 17 is a diagram illustrating a sequence of the fourth operation example according to the first embodiment;

FIG. 18 is an explanatory diagram illustrating a fifth operation example according to the first embodiment;

FIG. 19 is a diagram illustrating a sequence of the fifth operation example according to the first embodiment;

FIG. 20 is an explanatory diagram illustrating a sixth operation example according to the first embodiment;

FIG. 21 is a diagram illustrating a sequence of the sixth operation example according to the first embodiment;

FIG. 22 is an explanatory diagram illustrating a seventh operation example according to the first embodiment;

FIG. 23 is a diagram illustrating a sequence of the seventh operation example according to the first embodiment;

FIG. 24 is a diagram illustrating a sequence of an operation example according to the second embodiment;

FIG. 25 is a diagram illustrating a network to describe application execution according to a third embodiment;

FIG. 26 is a diagram illustrating a network to describe a basic policy according to the third embodiment;

FIGS. 27A and 27B are diagrams illustrating message formats according to the third embodiment;

FIG. 28 is a schematic diagram illustrating a system to describe Part 1 of an example of the third embodiment;

FIG. 29 is a diagram illustrating an operation of the system to in Part 1 of the example of the third embodiment;

FIG. 30 is a diagram illustrating a sequence of Part 1 of the example of the third embodiment;

FIGS. 31A and 31B are diagrams illustrating the flow of a process of each node according to the third embodiment;

FIG. 32 is a schematic diagram illustrating a system to describe Part 2 of the example of the third embodiment;

FIG. 33 is diagram illustrating operations of the system in Part 2 of the example of the third embodiment;

FIG. 34 is a diagram illustrating a sequence of Part 2(a) of the example of the third embodiment; and

FIG. 35 is a diagram illustrating a sequence of Part 2(b) of the example of the third embodiment.

### DESCRIPTION OF EMBODIMENTS

Hereinafter, modes for carrying out embodiments will be described with reference to the drawings.

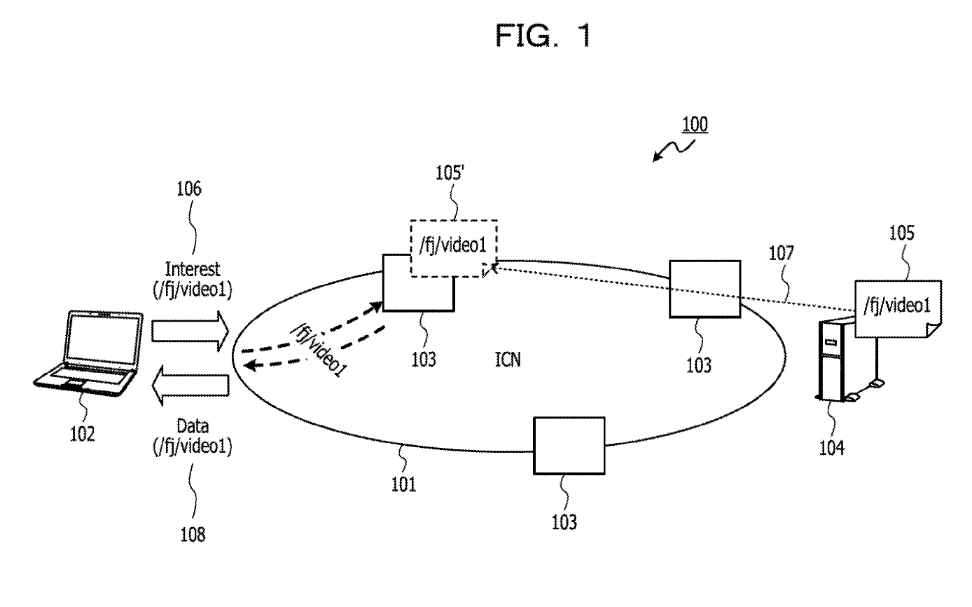

FIG. 1 is a diagram illustrating characteristics of ICN. The ICN has characteristics in which a node of a network capable of designating content has a cache. In FIG. 1, a request node (hereinafter referred to as a “requester”) 102 transmits Interest 106 which is a content request message to an ICN 100. In the request message Interest 106, content is designated with, for example, a format such as “/fj/video1”. Of a plurality of nodes 103 included in the ICN 100, one node acquires content (for example, “/fj/video1”) from a server 104 that is connected to the ICN 100 and holds the content designated with a request when the request message Interest 106 is received. Here, the content includes data, an application, and an application execution result. The node processes the acquired content (for example, “/fj/video1”). Then, the node returns response message Data 108 including the process result to the requester 102 which is a request source.

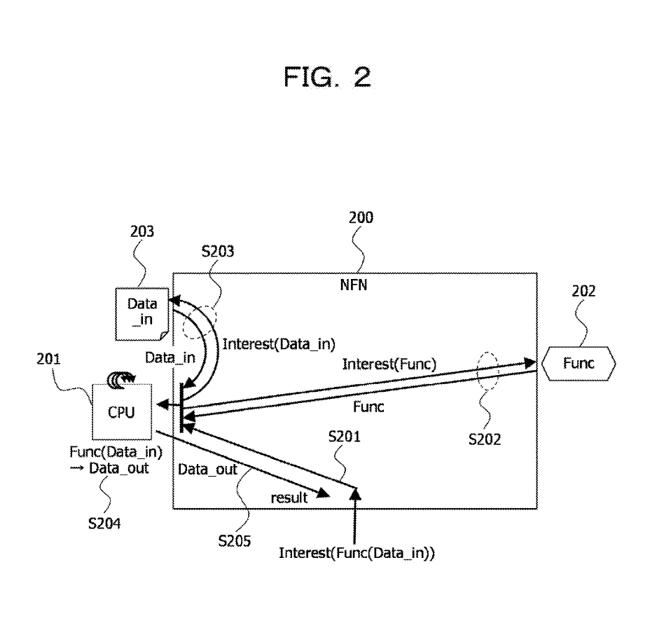

Here, named function networking (NFN) is known as networking obtained by expanding the ICN 100 so that application execution (in-network processing) in the ICN 100 (a node in the ICN 100) is designated and performed. FIG. 2 is a diagram illustrating a basic model of the NFN. In NFN 200, application execution is performed in the following procedure.

S201: a process is requested (an execution location is specified and a request is transmitted). The NFN 200 transmits a request message from a requester (not illustrated) to a node 201 of an application execution location. The application execution location is selected from a location in which there is an application, a location in which there is data, and other location (for example, an empty server). The request message has, for example, a format such as “Interest (Func (Data_in))”. This format has a meaning in which “an application “Func” is executed using “Data_in” as input data and an execution result is returned”.

S202 and S203: An application and data are acquired. A central processing unit (CPU) of the node 201 in the specified application execution location acquires the application “Func” from an application holding node 202 by transmitting another request message “Interest (Func)” to the application holding node 202 (S202). Similarly, the CPU of the node 201 acquires data “Data_in” from a data holding node 203 by further transmitting another request message “Interest (Data_in)” to the data holding node 203 (S203).

S204: A process is performed. The CPU of the node 201 in the application execution location executes the application “Func” acquired from the application holding node 202 using the data “Data_in” acquired from the data holding node 203” as an input. Then, the CPU outputs an execution result “Data out”.

S205: The result is transmitted. The CPU of the node 201 in the application execution location returns the execution result “Data_out” as a response message to the request source.

The followings are assumed as the premise of the NFN.

In application execution, an application and data are indispensable. The number of applications and the number of pieces of data can be plural. Hereinafter, the application and the data are collectively referred to as “element objects”.

The element objects are distributed and disposed in appropriate spots (nodes) in a network of the NFN 200. The element objects can dynamically be moved between nodes.

Different data from input data is output and responded as a result of the application execution.

The network of the NFN 200 is large-scale and it is difficult to perform centralized management on all the node state in real time at one spot.

Target applications include both network applications such as firewalls or filtering and user applications such as data analysis applications or image analysis applications. The applications are mounted in the forms of bytecodes (for example, Java (registered trademark)). The applications are platform-independent and are movable between nodes.

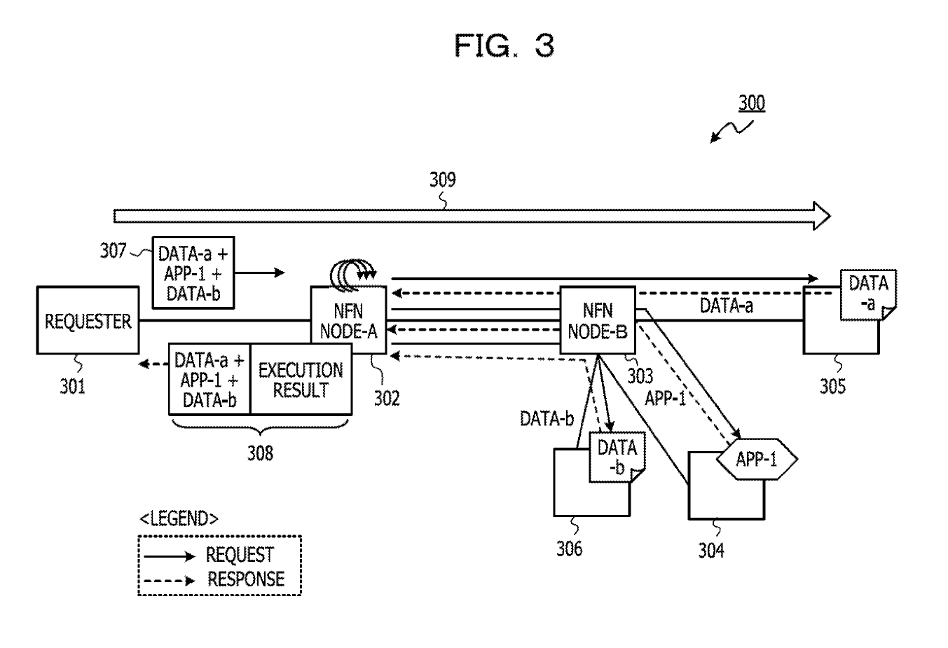

FIG. 3 is a diagram illustrating control of application execution in NFN 300 based on the foregoing premises. FIG. 3 illustrates a case in which App-1, Data-a, and Data-b are indispensable to execute the application. In this case, application execution is performed in the following procedure.

<Procedure 1>:

A requester 301 which is a requester for service execution gives a request message 307 requesting application execution to data (or an application). In FIG. 3, the request message 307 is designated by, for example, a name “Data-a+App-1+Data-b”. In this case, the request message 307 can be given to an element object indicated by a name “data-a” of the head of designation content. An element object to which the request message 307 is given is specified with the name of the request message 307 by the requester 301. In FIG. 3, a delivery path of the request message 307 is indicated by a solid arrow line.

<Procedure 2>

One of the NF nodes (application executable nodes) 302, 303, and the like on the path perform application execution. Typically, the first NFN node (an NFN node-A 302 in FIG. 3) on the path serves as an application execution location. For example, the NFN node-A 302 separately acquires an application and data indispensable and designated with the request message 307 from an application holding node 304 and data holding nodes 305 and 306 via an NFN node-B 303. Then, the NFN node-A 302 returns an application execution result as a response message 308 to the requester 301. The response message 308 includes include the name “Data-a+App-1+Data-b” designated with the request message 307 and an execution result of the application. In FIG. 3, delivery paths of response messages from the application holding node 304 and the data holding nodes 305 to 306 to the NFN node-A 302 and the response message 308 from the NFN node-A 302 to the requester 301 are indicated by dotted arrow lines.

In an application execution scheme illustrated in FIG. 3, typically, the first NFN node-A 302 (a node in the vicinity of the requester 301) on the path performs application execution. Therefore, the following problem occurs, for example, in a case in which an application, such as an image analysis application, in which input data (image data) of an application or to an application is larger than output data (analysis result) of an application.

There is a problem that transmission delay of the application or the data increases since an application or data has to be transmitted from a distant node to an application executable node. Thus, a response time (a time until a response is received after a user gives an application execution request) is late.

Normally, an application execution location (application execution load) may not be balanced between the first NFN node (a node in the vicinity of the request node) on the path and another NFN node on the path.

In the application execution, an execution location can also be considered to be decided by another logic according to a certain policy without being limited to the first NFN node on the path. However, in a single node, a location may not be determined according to a policy determination method (for example, in a case in which a policy designates a node in the vicinity of a destination) and the application execution may not be controlled.

In each embodiment to be described below, the above-described problems are resolved. First, basic policies (approaches) for the application execution according to the first embodiment are as follows.

<Approach 1>

According to a relation between sizes of input data to an application and output data, that is, a relation between an input data amount and an output data amount, the application is executed:

in the vicinity of a destination (distant from the requester) in case of the output data<Σ (the input data); and

in the vicinity of the requester in case of the output data>Σ (the input data). Here, “Σ (the input data)” means a sum of the sizes of a plurality of pieces of input data.

<Approach 2>

Further, loads between nodes are balanced centering on a specific location according to Approach 1 by reflecting a resource state of each node in decision of an application execution location. Here, “the resource” refers to, for example, a software environment capable of executing a hardware resource such as a processor capable of executing a designated application or a memory and/or a designated application.

That is, whether an application is executed is determined from information which can be locally obtained by each node according to the property (Approach 1) of the application and a resource state (Approach 2) of each node, and an application execution location is dynamically decided.

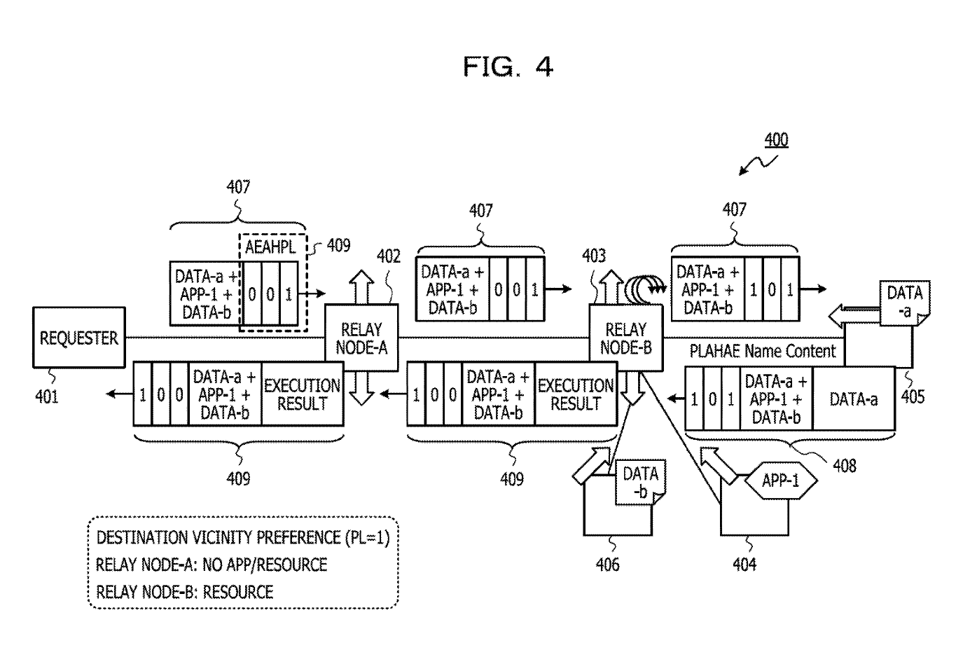

FIG. 4 is an explanatory diagram illustrating a communication system performing application execution based on the basic policy according to the first embodiment. In a communication system 400 of FIG. 4, as in the case of FIG. 3, a case in which App-1, Data-a, and Data-b are indispensable to execute the application is represented. In this case, the application execution is performed in the following procedures.

<Procedure 1>

In a request message 407 requesting to execute an application to be transmitted, the same name “Data-a+App-1+Data-b” as the request message 307 in FIG. 3 is designated. The request message 407 is transmitted to a specific element object (application or data). In the example of FIG. 4, as in the case of FIG. 3, the request message 407 can be given to an element object corresponding to the name “Data-a” of the head of the designated name “Data-a+App-1+Data-b”.

Further, in the first embodiment, as indicated by a dotted range 409 in FIG. 4, an execution policy bit PL (execution policy identification information), an application holding bit AH (application holding identification information), and an application executable bit AE (application executable identification information) are added to the request message 407. At least the execution policy identification information is set as identification information of a node.

According to the property of the application, a requester 401 or an edge node (a node at an entrance of a network which accommodates the requester 401) sets the execution policy bit PL of the request message 407 in one of a destination vicinity preference (=1) and a request vicinity preference (=0). The property of the application is the relation between the sizes of the input data to the application and the output data, as described in the above-described <Approach 1>.

That is, in case of “the output data<Σ (the input data)”, the execution policy bit PL is set in the destination vicinity preference (=1) so that an application is executed by a node in the vicinity of the destination (distant from the requester).

Conversely, in case of “the output data>Σ (the input data), the execution policy bit PL is set in the request vicinity preference (=0) so that the application is executed by the node in the vicinity of the requester 401.

In FIG. 4, a value 1 indicating the destination vicinity preference is set in the execution policy bit PL.

<Procedure 2>

A relay node-A 402 or a relay node-B 403 on the path also includes a nearby node which is not located on the path and performs the following operation according to whether the node has an application designated with the request message 407 (hereinafter referred to as a “designated application”) or a resource of the application execution. The relay node-A 402 or the relay node-B 403 sequentially sets a value 1 in the application holding bit AH and/or the application executable bit AE of the request message 407 received and transmitted by the self-node.

<Procedure 3>

A Data-a holding node 405 of a destination adds a “DATA-a” body which is a requested element object to the received request message 407. Then, the request message is transmitted as a response message 408 along a reverse path to the path of the request message 407.

<Procedure 4>

When the response message 408 is received, the relay node-A 402 and the relay node-B 403 perform the following operations. The relay node-A 402 and the relay node-B 403 compare the execution policy bit PL, the application holding bit AH, and the application executable bit AE between the time of transmitting the request message 407 and the time of receiving the response message 408 and autonomously decide an operation of the self-node. Based on the autonomously decided operation, each of the relay node-A 402 and the relay node-B 403 decides an application execution location in a preferential order of a destination node in which there is an element object with the maximum size, a destination node or a node close to the requester in the location/on the path of the requester 401, and a nearby node which is not on the path. As will be described below, a relative position of the self-node on the path can be understood with the application holding bits AH and the application executable bits AE of the request message 407 and the response message 408. Each node such as the relay node-A 402 and the relay node-B 403 autonomously decides whether to execute an application in consideration of these bits and the execution policy bit PL indicating whether an application is executed in the vicinity of the destination or the vicinity of the requester 401. In the example of FIG. 4, the relay node-B 403 decides to execute an application as a node which has a resource by which the application is executed in the closest vicinity of the destination (the Data-a holding node 405) on the path. The relay node-B 403 acquires “App-1” designated by the request message 407, “Data-a”, and “Data-b” from an “App-1” holding node 404, the Data-a holding node 405, and the Data-b holding node 406, respectively, and performs the application execution. The relay node-B 403 adds an execution result of the application to the response message 408 and transmits the response message 408 as a new response message 409.

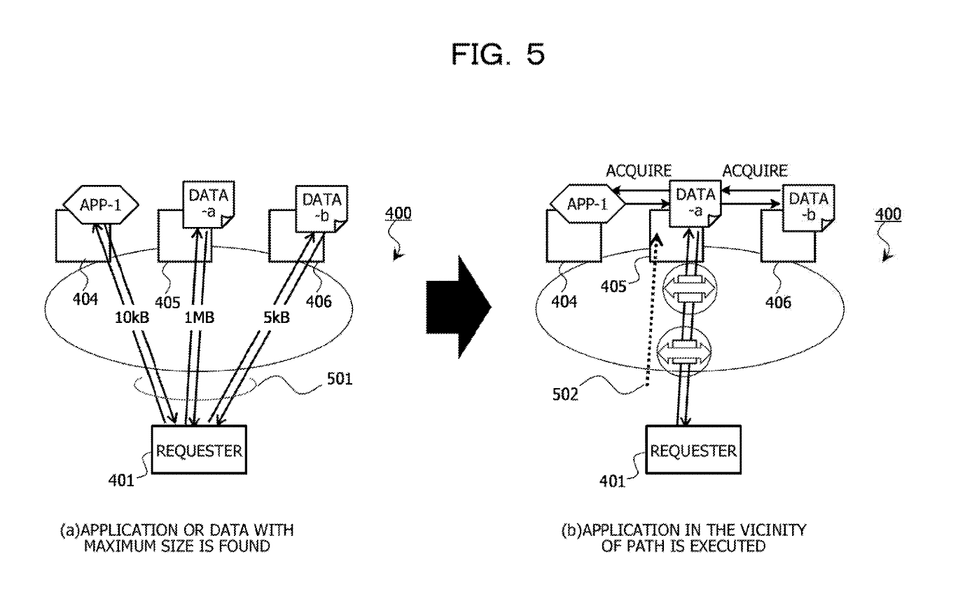

FIG. 5 is an explanatory diagram illustrating a communication system performing an application execution according to a second embodiment. A communication system 400 in FIG. 5 is of an extension type of the first embodiment of FIG. 4. The communication system 400 adds a method of deciding an element object of a destination and then performs the scheme of the first embodiment. In this case, the application execution is performed in the following procedure. In FIG. 5, the units to which the same reference numerals as those of FIG. 4 are given are assumed to indicate the same units as those in the case of FIG. 4.

<Procedure 1>

As in 501 of (a) of FIG. 5, the requester 401 searches for the size of an element object (an application or data) indispensable to execute the application on the communication system 400 in each of the application holding node 404, the Data-a holding node 405, and the Data-b holding node 406. As a result, the requester 401 specifies an element object with the maximum size (hereinafter referred to as a “specific object”). In the example of (a) of FIG. 5, the application holding node 404, the Data-a holding node 405, and the Data-b holding node 406 respond with sizes of “10 kilobytes (kB), “1 megabyte (MB)”, and “5 kB”, respectively, in response to a size search request from the requester 401. The requester 401 which is a receiver of the sizes specifies the Data-a holding node 405 responding with “1 MB” as a specific object.

<Procedure 2>

As indicated by 502 of (b) of FIG. 5, the requester 401 gives a destination of the request message as the specific object. The following nodes each perform the same process as that of the first embodiment of FIG. 4.

<Procedure 3>

As a result, the application execution is performed in the following preferential order. A node determining to perform the application execution acquires another element object in that location and returns a result of the application execution.

Priority 1: a node in which there is the specific object.

Priority 2: a node on a path reaching the specific object.

Priority 3: a node in the vicinity of the node on the path (a node which is not on the path).

As described above, according to the property of the application and a resource state of each node, an application is executed in the destination node in the location/on the path of the destination or requester, the node/destination node close to the requester, or the requester in the vicinity of the requester. Next, the application is executed in a node (without being limited to a specific node) in which there is a resource with which the application is executed in addition to the path and the vicinity of the path. Here, the “vicinity” refers to, for example, a node which is within k hops excluding nodes on the path from a target node.

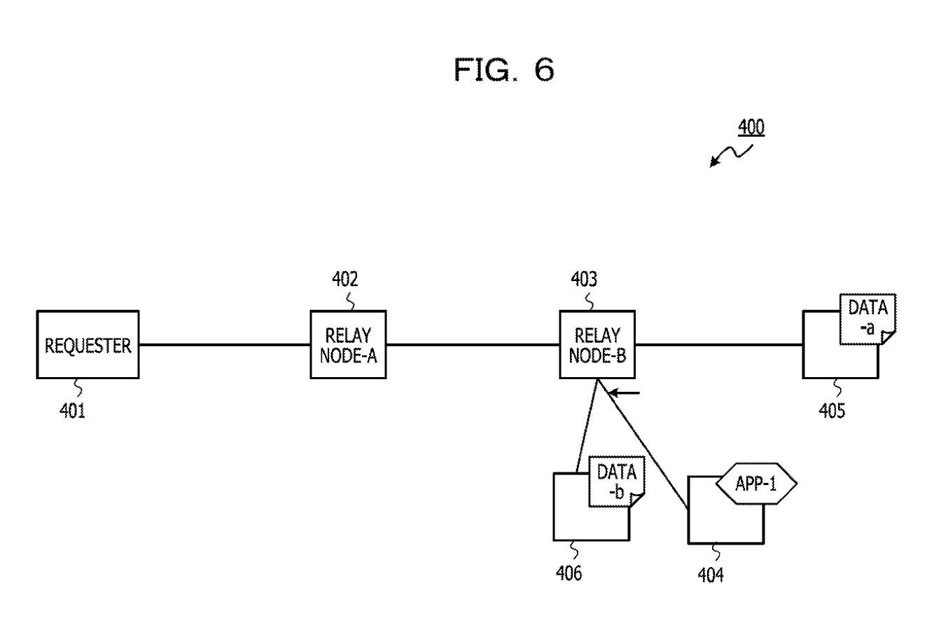

FIG. 6 is a diagram illustrating a configuration example of the communication system 400 performing the application execution according to the above-described first or second embodiment. The communication system 400 is configured to include six nodes, the requester 401, the relay node-A 402, the relay node-B 403, the “App-1” holding node 404, the Data-a holding node 405, and the Data-b holding node 406 to form a network. As an initial state, the “App-1” body is disposed in “App-1” holding node 404, the “Data-a” body is disposed in the Data-a holding node 405, and the “Data-b” body is disposed in the Data-b holding node 406. To execute the application, these element objects are indispensable. The requester 401 issues an execution request of the application.

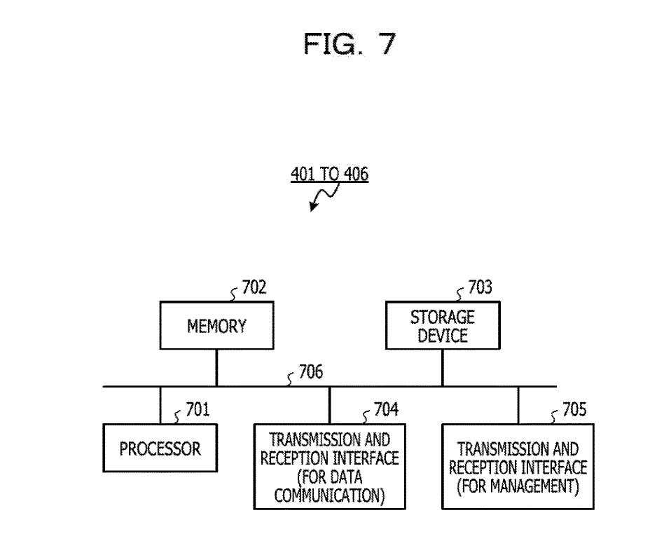

FIG. 7 is a diagram illustrating a hardware configuration example of a communication apparatus included in the node of one of the 401 or 406 in FIG. 6. The node is a general-purpose server as hardware. As illustrated in FIG. 7, a processor 701, a memory 702, a storage device 703, a transmission and reception interface (for data communication) 704, and a transmission and reception interface (for management) 705 are connected to each other by a bus 706. The storage device 703 is, for example, a hard disk storage device. The transmission and reception interface (for data communication) 704 is, for example, hardware that connects the node to a local area network (LAN). The transmission and reception interface (for management) 705 is, for example, hardware that connects the node to a maintenance network to which a management server is connected. When the processor 701 executes a program disposed in the memory 702 or the storage device 703, the node performs an operation defined as a program.

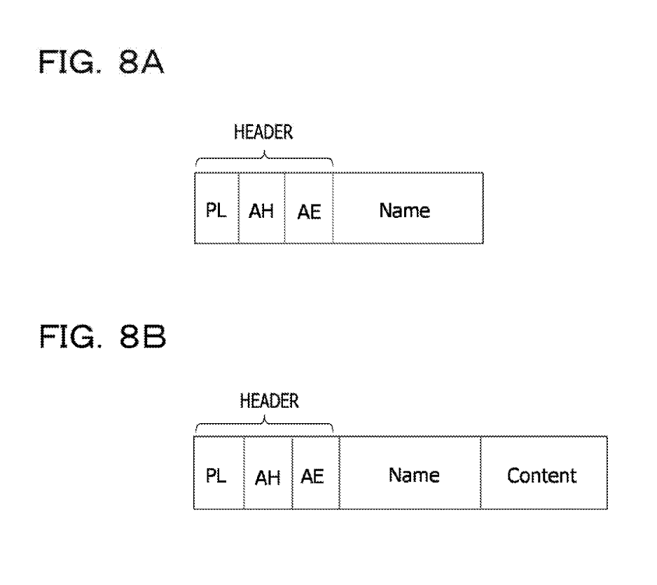

FIGS. 8A and 8B are diagrams illustrating format examples of the request message 407 and the response messages 408 and 409 communicated in the communication system 400 performing the application execution according to the first or second embodiment.

As illustrated in FIG. 8A, the request message 407 includes a header portion including an execution policy bit PL, an application holding bit AH, and an application executable bit AE and a name portion. The bits and the portions are defined as follows.

The execution policy bit PL (PoLicy) is a bit that takes a value 0 or 1. From the viewpoint of delay or a transmission amount, the execution policy bit P indicates whether execution of a target application in the vicinity of the requester 401 is advantageous (PL=0) or execution of the target application at a distance from the requester 401 (in the vicinity of the application or the data) is advantageous (PL=1). From the property of the target application, the case of the input data amount<the output data amount (for example, simple mergence of data) is determined in the application in the former. The opposite case (for example, image analysis) is determined in the latter. When the requester 401 transmits the request message or the edge node relays the request message, the execution policy bit PL is set based on the above-described determination result.

The application holding bit AH (AppHold) is a bit that takes a value 0 or 1. The application holding bit AH indicates that any node does not have the application designated by the name portion (FIG. 8A) of the request message 407 (AH=0) or has the application (AH=1). First, the requester 401 sets a value in the application holding bit AH of the request message 407 and transmits the request message 407 depending on a holding situation of the application. Then, when the node on the path (also including the vicinity of the path) has a designated application, the value 1 is set in the application holding bit AH of the received request message 407. When the node does not have the designated application, the value of the bit is not changed.

The application executable bit AE (AppExec) is a bit that takes a value 0 or 1. The application executable bit AE indicates that any node does not has a resource (a CPU or a memory) executing the application designated by the name portion of the request message 407 (AE=0) or has the resource (AE=1). First, the requester 401 sets a value in the application executable bit AE of the request message 407 and transmits the request message 407 depending on a holding situation of the resource executing the application. Then, when the node on the path (also including the vicinity of the path) has the resource, the value 1 is set in the application executable bit AE of the received request message 407. When the node does not have the resource, the value of the bit is not changed.

The name portion is a field that has a variable length and designates execution of an application to be requested. A name character string of element objects (an application and data) indispensable to execute the application is connected by “+” and is notated in the name portion. For example, the name portion is notated as “Data-a+App-1+Data-b”. “Data-a”, “App-1”, and “Data-b” notated in the name portion are names of the element objects. The request message 407 is routed to the element object corresponding to the name (in this case, “Data-a”) in the head of the name portion. Routing information corresponding to each element object is broadcasted in advance in a network from the presence location of each element object. Each node configures a routing table for the names of the element objects. Each node decides an output interface for the element object in the head of the name portion by Longest Prefix Match at the time of receiving the request message 407. Then, each node routes the received request message 407 to the output interface.

Next, as illustrated in FIG. 8B, each of the response messages 408 and 409 includes a header portion including an execution policy bit PL, an application holding bit AH, and an application executable bit AE, a name portion, and a content portion. The meanings of the portions other than the content portion are the same as those of the request message 407 in FIG. 8A. Here, the application holding bit AH and the application executable bit AE are not set again by each node, but are copied from the request message in the destination node. The application holding bit AH and the application executable bit AE are reset to 0 and are delivered to a subsequent node only when the application is executed by a node which is halfway on the path. The response messages 408 and 409 are not routed by the name portion. Each node stores transmission sources of the request message 407 corresponding to the response messages 408 and 409 and transmits the response messages 408 and 409 to the transmission sources. The content portion is defined as follows.

The content portion is a field that has a variable length and stores an execution result of an application to be requested or element objects (the application and the data). In a node, the body of an element object is stored in the content portion before the application is executed. For example, in the response message 408 of FIG. 4, the element object “Data-a” stored in the Data-a holding node 405 is stored in the content portion. After the application is executed, an execution result of the application is stored in the content portion. For example, the response message 409 of FIG. 4 is this case.

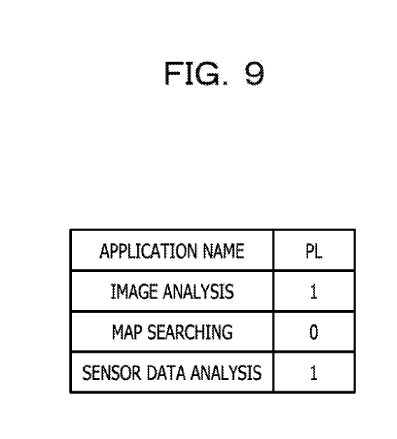

FIG. 9 is a diagram illustrating a configuration example of a PL setting table for setting the execution policy bit PL. As described in <Procedure 1> of the first embodiment in FIG. 4, as indicated by a dotted range 409 in FIG. 4, the execution policy bit PL, the application holding bit AH, and the application executable bit AE are added to the request message 407. At this time, in the property of the application, the destination vicinity preference (=1) or the request vicinity preference (=0) is set in the above-described procedure. As described above, the execution policy bit PL is set by the requester 401 or the edge node. Here, in many applications, a magnitude relation between the sizes of the “Σ (the input data)” and “the output data” described above can be estimated in advance. Accordingly, the value of the execution policy bit PL can also be estimated in advance. Accordingly, in the embodiment, for example, the requester 401 or the edge node has a PL setting table illustrated in FIG. 9 to decide whether the value of the execution policy bit PL is set to 1 or 0 for each application. Referring to the PL setting table of FIG. 9 stored in, for example, the memory 702 or the storage device 703 in FIG. 7 by the self-node for each application requesting execution, the requester 401 or the edge node decides the value of the execution policy bit PL added to the request message 407.

In the example of FIG. 9, in a case in which the application is an image analysis application, “the output data>Σ (the input data)” is satisfied since the input data is image data and the output data is an image analysis result. In this case, for example, when the application is executed by, for example, the relay node-B 403 in the vicinity of, for example, the Data-a holding node 405 (distant from the requester 401) which holds the “Data-a” body which is the image data, a transmission distance of the “Data-a” body is shortened, and thus execution efficiency of the application is better. Accordingly, in the PL setting table of FIG. 9, 1 is stored as the value of the execution policy bit PL in the image analysis application.

In a case in which the application is a map searching application, “the output data>Σ (the input data)”since input data is a character string keyword indicating latitude and longitude data or a spot and output data is map data. In this case, when the application is executed by, for example, the relay node-A 402 in the vicinity of the requester 401 receiving the execution result of the application which is the output data, a transmission distance of the output data is shortened, and thus execution efficiency of the application is better. Accordingly, in the PL setting table of FIG. 9, 0 is stored as the value of the execution policy bit PL in the map searching application.

Further, in a case in which the application is a sensor data analysis application, input data is sensor data and output data is an analysis result. Therefore, “the output data<Σ (the input data)” is generally satisfied. In this case, for example, when the application is executed by, for example, the relay node-B 403 in the vicinity of, for example, the Data-a holding node 405 (distant from the requester 401) which holds the “Data-a” body which is the sensor data, a transmission distance of the “Data-a” body is shortened, and thus execution efficiency of the application is better. Accordingly, in the PL setting table of FIG. 9, 1 is stored as the value of the execution policy bit PL in the sensor data analysis application.

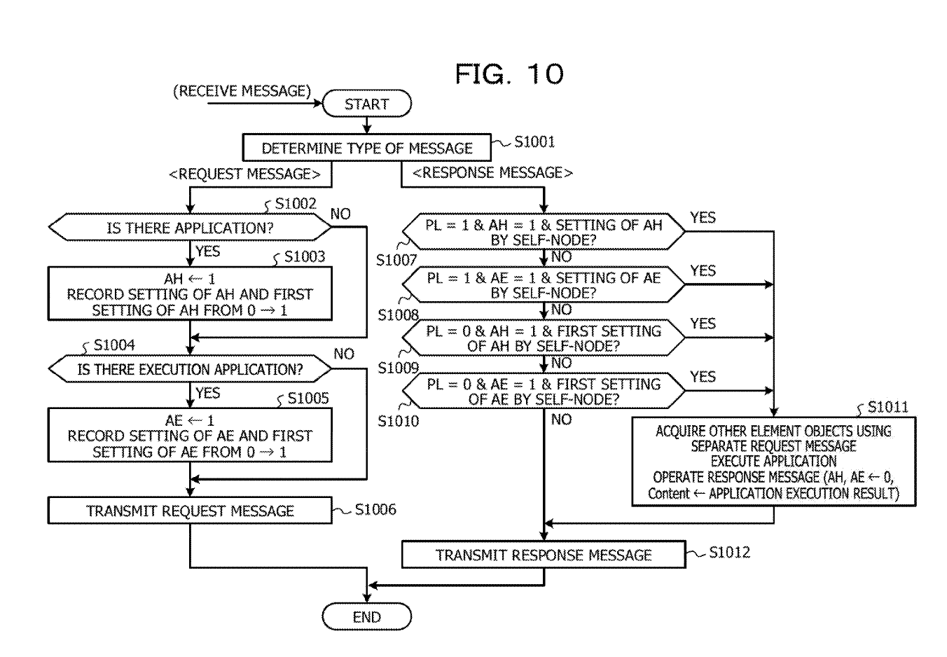

FIG. 10 is a flowchart illustrating an example of a message transmission process of the relay node-A 402 or the relay node-B 403 in the communication system 400 performing the application execution according to the above-described first or second embodiment. The message transmission process is an operation when the processor 701 in FIG. 7 included in the relay node-A 402 or the relay node-B 403 executes a message transmission processing program loaded from the storage device 703 and stored in the memory 702.

First, when a message is received, the processor 701 determines a type of the message (S1001). For example, the type of message is defined with a separate header or the like to be determined.

In a case in which the received message is the request message 407 in the determination of S1001, the processor 701 first checks whether the self-node has an application designated by the name portion (see FIG. 8A) of the request message 407 (S1002).

When the determination of S1002 is YES, the processor 701 sets a value 1 in the application holding bit AH of the received and transmitted request message 407. The processor 701 records setting of the application holding bit AH in the memory 702. Further, the processor 701 records in the memory 702 whether the value 1 is first set from the value 0 in the AH (whether the AH of the received request message 407 is 0 and the self-node overwrites 1 on the AH) (until now, S1003).

When the determination of S1002 is NO, the processor 701 skips the foregoing process of S1003 and does not rewrite the AH bit value of the header portion of the request message 407.

Next, the processor 701 checks whether the self-node has a resource for executing the application designated by the name portion (see FIG. 8A) of the request message 407 (S1004). Here, the “resource” refers to, for example, a hardware resource such as the processor 701 or the memory 702 capable of executing the designated application and/or a software environment capable of executing the designated application.

when the determination of S1004 is YES, the processor 701 sets a value 1 in the application executable bit AE of the received and transmitted request message 407. The processor 701 records setting of the application executable bit AE in the memory 702. Further, the processor 701 records in the memory 702 whether the value 1 is first set from the value 0 in the AE (whether the AE of the received request message 407 is 0 and the self-node overwrites 1 on the AE) (until now, S1005).

When the determination of S1004 is NO, the processor 701 skips the foregoing process of S1005 and does not rewrite the AE bit value of the header portion of the request message 407.

After the series of control processes from S1002 to S1005 described above, the processor 701 sets the element object in the head of the name portion as a destination and transmits the received request message 407 to a subsequent node (S1006). Then, the processor 701 ends the message transmission process illustrated in the flowchart of FIG. 10.

In a case in which the received message is the response message 408 or 409 in the determination of S1001, the processor 701 first performs a series of determination processes from S1007 to S1010 to be described below by checking the value of each bit of the header portion of the response message 408 or 409.

First, the processor 701 determines whether the setting of the value 1 in the execution policy bit PL, the setting of the value 1 in the application holding bit AH, and the setting of 1 in the application holding bit AH by the self-node are stored in the memory 702 (S1007). In FIG. 10, “and” indicates logical AND indicated by the “&” sign.

When the determination of S1007 is YES, the processor 701 transitions the process to S1011 and performs the application execution process.

When the determination of S1007 is NO, the processor 701 determines whether setting of the value 1 in the execution policy bit PL, the setting of the value 1 of the application executable bit AE, and setting of 1 in the application executable bit AE by the self-node are stored in the memory 702 (S1008).

When the determination of S1008 is YES, the processor 701 transitions the process to S1011 and performs the application execution process.

As will be described below, for example, the Data-a holding node 405 transmits the response message 408 that has each bit value of the header portion of the request message 407 without change along a reverse path to a transmission path. Each of the nodes such as the relay node-A 402, the relay node-B 403, and the Data-a holding node 405 stores whether each request message 407 is received from which node. When the response message 408 or 409 is received, each node transmits the received response message 408 or 409 to a node of the transmission source stored in regard to the request message 407 corresponding to the received response message. As a result, the response message 408 or 409 is relayed in a reverse path to a transmission path along which the request message 407 corresponding to the response message is relayed. Then, in S1007 or S1008, for example, when the relay node-B 403 first determines that the value of the AH or AE of the response message 408 is recorded as 1 and the value of the AH or AE in the self-node is recorded as 1, the self-node serves as an application executable node closest to the destination node. Accordingly, in this case, when the value of the execution policy bit PL of the response message 408 or 409 is set to the value 1 of the destination vicinity preference, the relay node-B 403 which is the self-node can be determined to be a node performing the application execution process. As the destination preference at this time, the self-node is first determined to hold the application (S1007). Next, it is determined whether the self-node has the resource for executing the application (S1008).

When the determination of S1008 is NO, the processor 701 determines whether the setting of the value 0 in the execution policy bit PL, the setting of the value 1 in the application holding bit AH, and the first setting of 1 in the application holding bit AH by the self-node are stored in the memory 702 (S1009).

When the determination of S1009 is YES, the processor 701 transitions the process to S1011 and performs the application execution process.

When the determination of S1009 is NO, the processor 701 determines whether setting of the value 0 in the execution policy bit PL, the setting of the value 1 of the application executable bit AE, and first setting of 1 in the application executable bit AE by the self-node are stored in the memory 702 (S1010).

When the determination of S1010 is YES, the processor 701 transitions the process to S1011 and performs the application execution process.

In S1009 or S1010, for example, when the relay node-A 402 first determines that the value of the AH or AE of the response message 408 is recorded as 1 and the value of the AH or AE is set by the self-node, the self-node serves as an application executable node closest to the requester 401. Accordingly, in this case, when the value of the execution policy bit PL of the response message 408 or 409 is set to the value 0 of the requester vicinity preference, the relay node-A 402 which is the self-node can be determined to be a node performing the application execution process. As the destination preference at this time, the self-node is first determined to hold the application (S1009). Next, it is determined whether the self-node has the resource for executing the application (S1010).

When one of the series of processes from S1007 to S1010 described above is determined to be YES, the processor 701 performs the application execution process (S1011).

In S1011, the processor 701 acquires other element objects indispensable to execute the application which is not held by the self-node using a separate request message and performs the application execution. That is, the processor 701 performs the following process on an element object which is not held by the self-node in an element object group “App-1”, “Data-a”, and “Data-b” designated in the name portion of the received response message 408 or 409. The processor 701 generates the request message in which the element object is designated in the name portion and transmits the request message to the network. As a result, the processor 701 acquires the element objects from the “App-1” holding node 404, the Data-a holding node 405, or the Data-b holding node 406 (see FIG. 4) in which the element object is a destination.

In S1011, when the application execution is completed, the processor 701 generates the following response message 409. The processor 701 resets the values of the application holding bit AH and the application executable bit AE of the header portion to 0 in the response message 409 so that the other nodes do not execute the application. Then, the processor 701 stores an application execution result in the content portion (see FIG. 8B).

After the process of S1011 described above, the processor 701 transmits the generates response message 409 to the node in a direction in which the request message 407 that has the same header portion of the header portion of the response message 409 is received (S1012).

In a case in which the determination of S1010 described above is NO, the processor 701 transmits the received response messages 408 and 409 without change to the nodes in a reception direction of the request message 407 which has the same header portion as the head portion of the response message 409 (S1012).

Thereafter, the processor 701 ends the message transmission process illustrated in the flowchart of FIG. 10.

The configurations of FIGS. 7 to 9 and seven operation examples of the first embodiment based on the message transmission process of FIG. 10 will be described below.

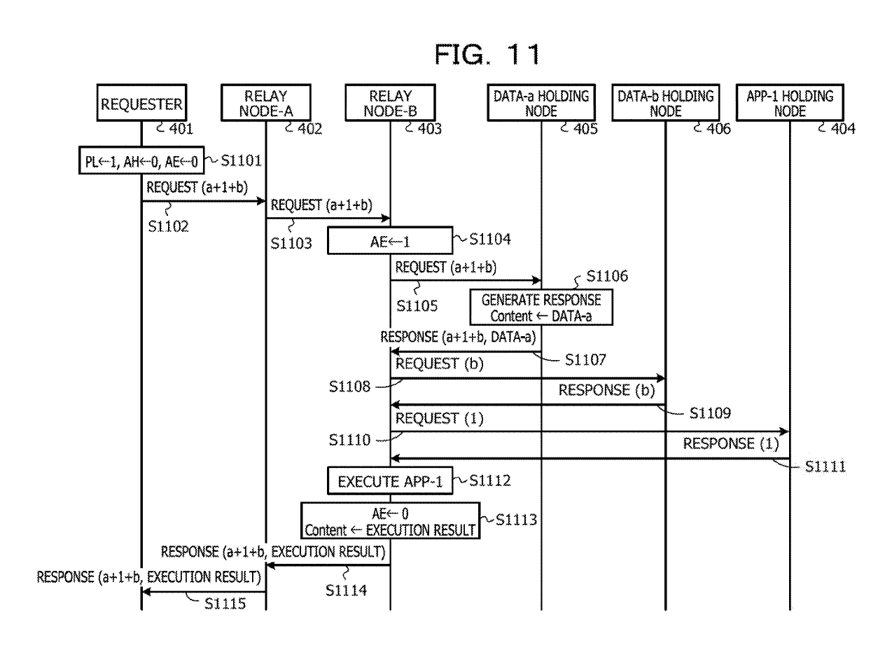

First, a first operation example of the first embodiment will be described with reference to the above-described explanatory diagram of FIG. 4 and the sequence diagram of FIG. 11. The first operation example illustrated in FIGS. 4 and 11 is an example of a case in which 1 is set in the execution policy bit PL and there is the resource for executing the application only in the relay node-B 403.

<Operation Pattern 1>

The requester 401 sets 0 or 1 as the value of the execution policy bit PL of the request message 407 to be transmitted by referring to the PL setting table of FIG. 9 from the property of the application to be executed. As a described above, the execution policy bit PL is set by the relay node-A 402 (see FIG. 6) corresponding to the edge node rather than the requester 401. The requester 401 is configured so that the destination (the object in the head, Routable Prefix) indicated by the name portion of the request message 407 is one of the element objects (the application or the data) and transmits the request message 407.

The first operation example of FIGS. 4 and 11 is a case in which the application to be executed is “the output data<Σ (the input data)” as in the image analysis application or the sensor data analysis application. As a result, referring to the PL setting table of FIG. 9, the requester 401 sets the value 1 indicating the destination vicinity preference in the execution policy bit PL of the request message 407 to be transmitted. Next, in the first operation example of FIG. 4, the requester 401 sets the name “Data-a+App-1+Data-b” as the name portion of the request message 407. As a result, the destination node is the Data-a holding node 405 that holds the “Data-a” body corresponding to the name “data-a” in the head of the name portion. In this way, the requester 401 sets PL=1, AH=0, and AE=0 according to the above-described <Operation Pattern 1> and generates the request message 407 in which name “Data-a+App-1+Data-b” is stored in the name portion (S1101 of FIG. 11). Then, the requester 401 transmits the generated request message 407 to the relay node-A 402 according to the above-described <Operation Pattern 1> (S1102). In FIG. 11, the request message 407 in which “Data-a+App-1+Data-b” is stored in the name portion is simply notated as a “request (a+1+b)”.

Each of the relay node-A 402 and the relay node-B 403 on a path reaching the destination node receiving the request message 407 executes the above-described message transmission process as follows according to the series of control operations from S1001 to S1006 of the flowchart of FIG. 10.

<Operation Pattern 2>

When the relay node has the designated application in the request message 407, including the nearby node (indicated by a thick-line arrow), the determination of S1001→S1002 of FIG. 10 enables control of YES→S1003→S1006. As a result, the relay node turns on the application holding bit AH of the request message 407 (sets the value 1). Then, the relay node stores the setting of AH=1 and whether to first set AH=1 in the memory 702. Thereafter, the relay node transmits the request message 407.

<Operation Pattern 3>

When the relay node has no designated application and has the resource for the execution, including the nearby node (thick line arrow), the determination of S1001→S1002 of FIG. 10 and the determination of NO→S1004 enable control of YES→S1005→S1006. As a result, the relay node turns on the application executable bit AE of the request message 407. Then, the relay node stores the setting of AE=1 and whether to first set AE=1 in the memory 702. Thereafter, the relay node transmits the request message 407.

<Operation Pattern 4>

When the relay node has neither the designated application nor the resource for the execution, including the nearby node (thick line arrow), the determination of S1001→S1002 of FIG. 10 and the determination of NO→S1004 enable control of NO→S1006. As a result, the relay node transmits the request message 407 without change.

In the foregoing operation 2, 3, or 4, each node inspects whether to perform searching within k hops of the self-node as the “vicinity” of the self-node in advance and has information.

In the first operation example of FIGS. 4 and 11, the relay node-A 402 has neither “App-1” which is the designated application nor the resource for the execution. Therefore, the relay node-A 402 relays the request message 407 to the relay node-B 403 while the value 0 remains in both of the application holding bit AH and the application executable bit AE of the request message 407 according to the above-described <Operation Pattern 4> (S1103 of FIG. 11).

Next, the relay node-B 403 has no “App-1” and has the resource for the execution. Therefore, the relay node-B 403 returns on the application executable bit AE in the request message 407 according to the above-described <Operation Pattern 3> (rewrites the value to the value 1). The relay node-B 403 stores the setting of AE=1 and the first setting of AE=1 in the memory 702 (until now, S1104 of FIG. 11). Then, the relay node-B 403 transmits the request message 407 to the Data-a holding node 405 (S1105 of FIG. 11).

The destination node (the Data-a holding node 405 in the example of FIG. 4) determines each bit of the header of the request message 407 and operates as follows.

<Operation Pattern 5>

When the destination node holds the designated application in the request message 407 and has the resource for the execution, the self-node executes the designated application. As a result, the destination node stores the application execution result in the content portion (see FIG. 8B) of the response message 408. Then, the destination node relays the response message 408 along a reverse path to the path of the request message 407 corresponding to the response message 408. At this time, the destination node clears the application holding bit AH and the application executable bit AE of the header portion of the response message 408 (sets the value 0).

<Operation Pattern 6>

The destination node performs the following operation when the application holding bit AH or the application executable bit AE of the request message 407 is turned on in a case in which the destination node has neither the designated application in the request message 407 nor the resource for the execution. The destination node generates the response message 408 and copies bit values of the PL, AH, and AE of the request message 407 to the header portion. Then, the destination node stores the “Data-a” body in the content portion. Then, the destination node transmits the response message 408 along the reverse path to the path of the request message 407 corresponding to the response message 408.

<Operation Pattern 7>

The destination node performs the following operation when both of the application holding bit AH and the application executable bit AE of the request message 407 are turned off (value 0) in a case in which the destination node has neither the designated application in the request message 407 nor the resource for the execution. The destination node stores an error (application execution disability) in the content portion of the response message 408. Then, the destination node transmits the response message 408 along the reverse path to the path of the request message 407 corresponding to the response message 408.

The first operation example of FIGS. 4 and 11 is a case in which the Data-a holding node 405 which is the destination node has neither the designated application in the request message 407 nor the resource for the execution and only the application executable bit AE of the request message 407 is turned on. Accordingly, the Data-a holding node 405 performs the following operation according to the above-described <Operation Pattern 6>. The Data-a holding node 405 generates the response message 408 and copies the bit values of the PL, AH, and AE of the request message 407 in the header portion. Then, the Data-a holding node 405 stores the “Data-a” body in the content portion (S1106 of FIG. 11). Then, the Data-a holding node 405 transmits the response message 408 to the relay node-B 403 (S1107 of FIG. 11). In FIG. 11, the name “Data-a+App-1+Data-b” is stored in the name portion and the response message 408 in which the “Data-a” body is stored in the content portion is simply notated as a “response (a+1+b, Data-a)”.

The relay node on the path along which the response message 408 is received from the destination node performs the above-described message transmission process as follows according to the series of control operations of S1001→S1007 to S1012 of the flowchart of FIG. 10.

<Operation Pattern 8>

The relay node performs the following operation in a case in which the PL bit=1 (the destination vicinity preference) of the header portion of the response message 408, a bit of one of the AH and AE is turned on, and the self-node turns on the bit of the AH or AE including the vicinity. The relay node performs S1011 when the determination of one of S1007 and S1008 of FIG. 10 is YES. This condition is satisfied in the node closest to the node of the destination which first receives the response message 408 transmitted from the node of the destination among the relay nodes which has the designated application in the name portion of the response message 408 or the resource for the execution. Conversely, the relay node performs the following operation in a case in which the PL bit=0 (the requester vicinity preference) of the header portion of the response message 408 is set, the bit of one of the AH and the AE is turned on, and the self-node “first” turns on the bit of the AH or AE including the vicinity. The relay node performs S1011 when the determination of S1007 and S1008 of FIG. 10 is NO and continuously the determination of one of S1009 and S1010 is YES. This condition is satisfied in the node in a location closest to the node of the requester 401 which finally receives the response message 408 transmitted from the node of the destination among the relay nodes which has the designated application in the name portion of the response message 408 or the resource for the execution. When any of the foregoing conditions is established, the relay node acquires other element objects indispensable to execute the application not held by the self-node using another request message and performs the application execution in S1011 of FIG. 10. When the application execution is completed, the relay node newly generates the response message 409. The relay node resets the values of the application holding bit AH and the application executable bit AE of the header portion to 0 in the generated response message 409 so that the other nodes do not execute the application. Then, the relay node stores an application execution result in the content portion. Thereafter, in S1012 of FIG. 10, the relay node relays the generated response message 409 to the issue source of the request message 407 which has the same header portion as the header portion (along the reverse path to the path of the request message 407).

<Operation Pattern 9>

In a case other than the foregoing <Operation Pattern 8> in the determination of the response message 408, all the determination from S1007 to S1010 of FIG. 10 is NO. As a result, in S1012 of FIG. 10, the relay node relays the response message 408 without change to the issue source of the request message 407 which has the same header portion as the header portion (along the reverse path to the path of the request message 407).

In the first operation example of FIGS. 4 and 11, when the response message 408 arrives at the relay node-B 403, the PL bit=1 is set, the bit of the AE is turned on, and the relay node-B 403 stores the setting of AE=1 in the memory 702. Therefore, the relay node-B 403 determines to execute “App-1” according to the above-described <Operation Pattern 8>. The relay node-B 403 first generates another request message in which the name “Data-b” corresponding to one of the element objects not held by the self-node is stored in the name portion. Then, the relay node-B 403 transmits the request message to the network (S1108 of FIG. 11). In FIG. 11, the other request message is simply notated as a “request (b)”. The Data-b holding node 406 responds to the other request message and transmits the response message in which the “Data-b” body is stored in the content portion to the relay node-B 403 (S1109 of FIG. 11). In FIG. 11, the response message is simply notated as a “response (b)”. Similarly, the relay node-B 403 generates another request message in which the name “App-1” corresponding to one of the element objects not held by the self-node is stored in the name portion. Then, the relay node-B 403 transmits the request message to the network (S1110 of FIG. 11). In FIG. 11, the other request message is simply notated as a “request (1)”. The App-1 holding node 404 responds to the other request message and transmits the response message in which the “App-1” body is stored in the content portion to the relay node-B 403 (S1111 of FIG. 11). In FIG. 11, the response message is simply notated as a “response (1)”. Thereafter, the relay node-B 403 extracts the “Data-a” body stored in the response message 408. Then, the relay node-B 403 executes a program indicated by the “App-1” body using “Data-a” and “Data-b” as input data (S1112 of FIG. 11). As a result, the relay node-B 403 resets the application executable bit AE in the header portion to 0 (the application holding bit AH is originally 0). Then, the relay node-B 403 newly generates the response message 409 in which the execution result is stored in the content portion (S1113 of FIG. 11). The reason why AE=0 is set is that another node does not execute an application. Then, the relay node-B 403 transmits the response message 409 to the relay node-A 402 (S1114 of FIG. 11). In FIG. 11, the response message 409 is simply notated as a “response (a+1+b, execution result)”.

In the relay node-A 402, both of the application holding bit AH and the application executable bit AE of the header portion of the received response message 409 are turned off. The relay node-A 402 has neither “App-1” which is the designated application” nor the resource for the execution. Accordingly, the relay node-A 402 relays the received response message 409 without change to the requester 401 according to the above-described <Operation Pattern 9> (S1115 of FIG. 11).

The requester 401 extracts and receives the execution result of the application from the content portion of the received response message 409.

As described above, in a case in which the value of the execution policy bit PL is set to 1 (the destination vicinity preference) in the first embodiment, the application execution is performed in the following priority:

Priority 1: a node in which there is an element object with a maximum size;

Priority 2: a node on the path reaching the element object (a node as close to the element object of a designation as possible); and

Priority 3: a node which is not on the path and is in the vicinity of the node on the path (a node within hips from the node on the path).

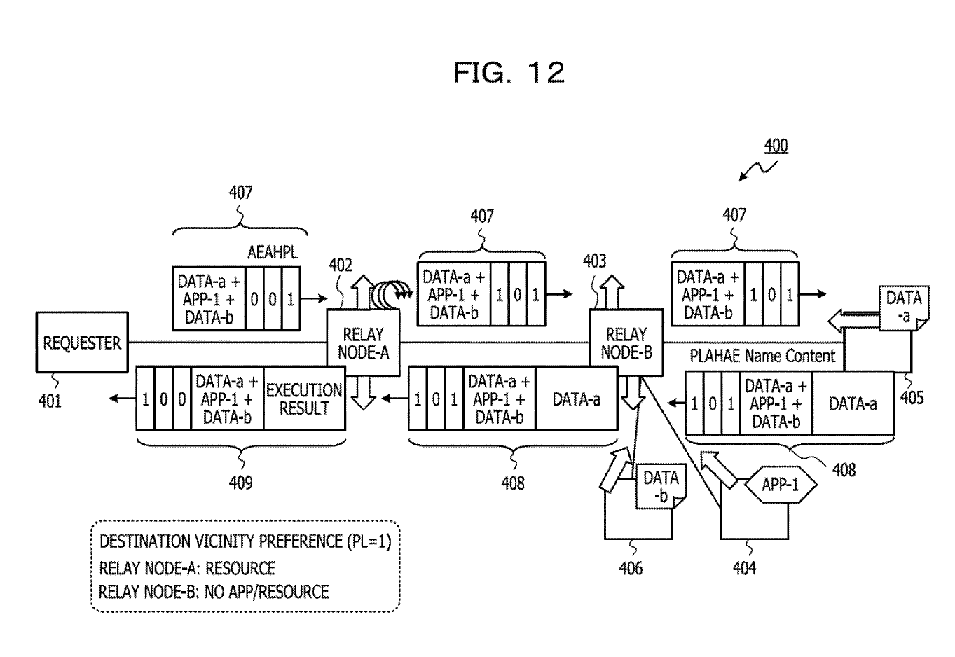

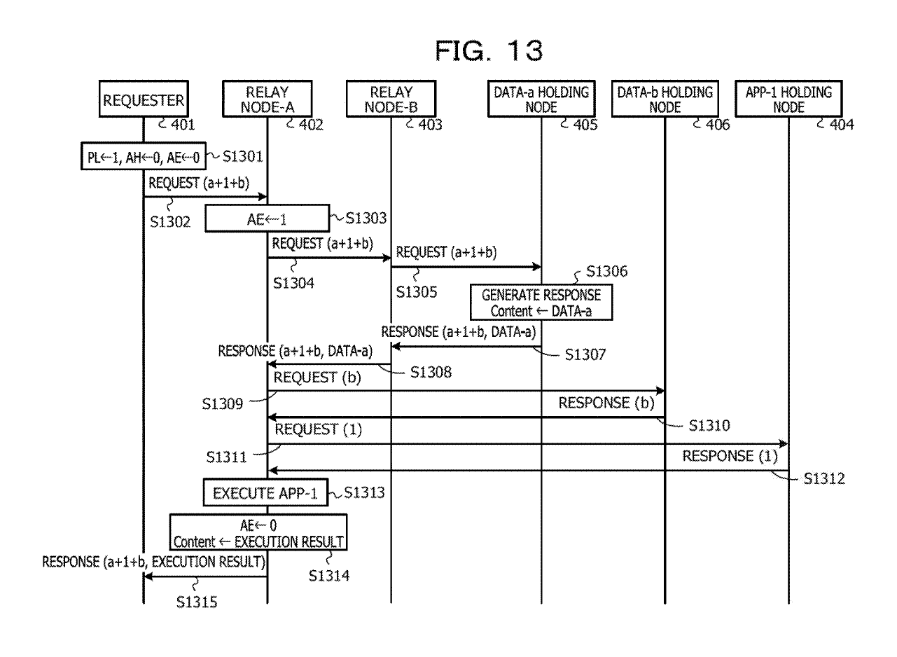

Next, a second operation example of the first embodiment will be described with reference to the explanatory diagram of FIG. 12 and the sequence diagram of FIG. 13. The second operation example illustrated in FIGS. 12 and 13 is an example of a case in which 1 is set in the execution policy bit PL and there is the resource for executing the application only in the relay node-A 402. A simple notation method in FIG. 13 is the same as that of the first operation example of FIG. 11.

First, the requester 401 performs the following control operation according to the above-described <Operation Pattern 1>. As in the case of the first operation example of FIG. 4, the second operation example of FIG. 12 is, for example, a case in which the application to be executed is “the output data<Σ (the input data)” as in the image analysis application or the sensor data analysis application. As a result, the requester 401 performs the following control operation according to the above-described <Operation Pattern 1>. Referring to the PL setting table of FIG. 9, the requester 401 sets the value 1 indicating the destination vicinity preference in the execution policy bit PL of the request message 407 to be transmitted. Then, the requester 401 sets the name “Data-a +App-1+Data-b” as the name portion of the request message 407 (until now, S1301 of FIG. 13). Then, the requester 401 transmits the request message 407 generated in this way to the relay node-A 402 (S1302 of FIG. 13).

Each of the relay node-A 402 and the relay node-B 403 on a path reaching the destination node executes the message transmission process according to <Operation Pattern 2>, <Operation Pattern 3>, or <Operation Pattern 4> described above in the description of the first operation example.

In the second operation example of FIGS. 12 and 13, the relay node-A 402 does not have no “App-1” and has a resource for the execution. Therefore, the relay node-A 402 performs the following control operation according to the above-described <Operation Pattern 3>. The relay node-A 402 turns on the application executable bit AE in the request message 407. The relay node-A 402 stores the setting of AE=1 and the first setting of AE=1 in the request message 407 in the memory 702 (FIG. 7) (until now, S1303 of FIG. 13). Then, the relay node-A 402 transmits the request message 407 to the relay node-B 403 (S1304 of FIG. 13).

Subsequently, the relay node-B 403 has neither “App-1” which is the designated application nor the resource for the execution. Therefore, the relay node-B 403 does not change the values of the AH and AE according to the above-described <Operation Pattern 4> and transmits the request message 407 to the Data-a holding node 405 without change (S1305 of FIG. 13).

The Data-a holding node 405 which is the destination node has neither “App-1” designated by the request message 407 nor the resource for the execution and only the application executable bit AE of the request message 407 is turned on. Accordingly, the Data-a holding node 405 performs the following operation according to the above-described <Operation Pattern 6> as in the first operation example of FIG. 4. The Data-a holding node 405 generates the response message 408 and copies the bit values of the PL, AH, and AE of the request message 407 to the header portion. Then, the Data-a holding node 405 stores the “Data-a” body in the content portion (S1306 of FIG. 13). Then, the Data-a holding node 405 transmits the response message 408 to the relay node-B 403 (S1307 of FIG. 13).

The relay node on the path along which the response message 408 or 409 is received from the Data-a holding node 405 performs the transmission process/the application execution process of the response message 408 or 409 according to <Operation Pattern 8> or <Operation Pattern 9> described above in the description of the first operation example.

The relay node-B 403 has neither “App-1” designated in the name portion of the response message 408 by the self-node including the vicinity nor the resource for the execution although the PL=1 and AE=1 are set in the received response message 409. Accordingly, the relay node-B 403 relays the received response message 409 to the relay node-A 402 without change according to the above-described <Operation Pattern 9> (S1308 of FIG. 13).

When the response message 408 arrives at the relay node-A 402, the PL bit=1 is set and the AE bit is turned on. The relay node-A 402 stores setting of AE=1 in the memory 702. Therefore, the relay node-A 402 determines to execute “App-1” according to the above-described <Operation Pattern 8>. As a result, the relay node-A 402 performs the series of control operations from S1309 to S1312 of FIG. 13 as in the series of control operations from S1108 to S1111 of the first operation example of FIG. 11. Thus, the relay node-A 402 acquires the “App-1” body and the “Data-b” body not held by the self-node from the “App-1” holding node 404 and the Data-b holding node 406 via the relay node-B 403, respectively, by other request messages. Thereafter, the relay node-A 402 extracts the “Data-a” body stored in the response message 408 and executes a program indicated by the “App-1” body using “Data-a” and “Data-b” as input data (S1313 of FIG. 13). As a result, the relay node-A 402 resets the application executable bit AE to 0 in the header portion (the application holding bit AH is originally 0). Then, the relay node-A 402 newly generates the response message 409 in which the execution result is stored in the content portion (S1314 of FIG. 13). Then, the relay node-A 402 transmits the response message 409 to the requester 401 (S1315 of FIG. 13).

Finally, the requester 401 receives the execution result of the application from the content portion of the received response message 409.

In this way, in the second operation example of FIGS. 12 and 13, the execution policy bit PL=1 (destination vicinity preference) is designated when the requester 401 transmits the request message 407. However, any relay node does not hold “App-1” and the relay node having the resource for executing “App-1” is only the relay node-A 402. Accordingly, although the relay node-A 402 is a relay node distant from the Data-a holding node 405 which is the destination node, the relay node-A 402 capable of uniquely executing “App-1” executes “App-1”.

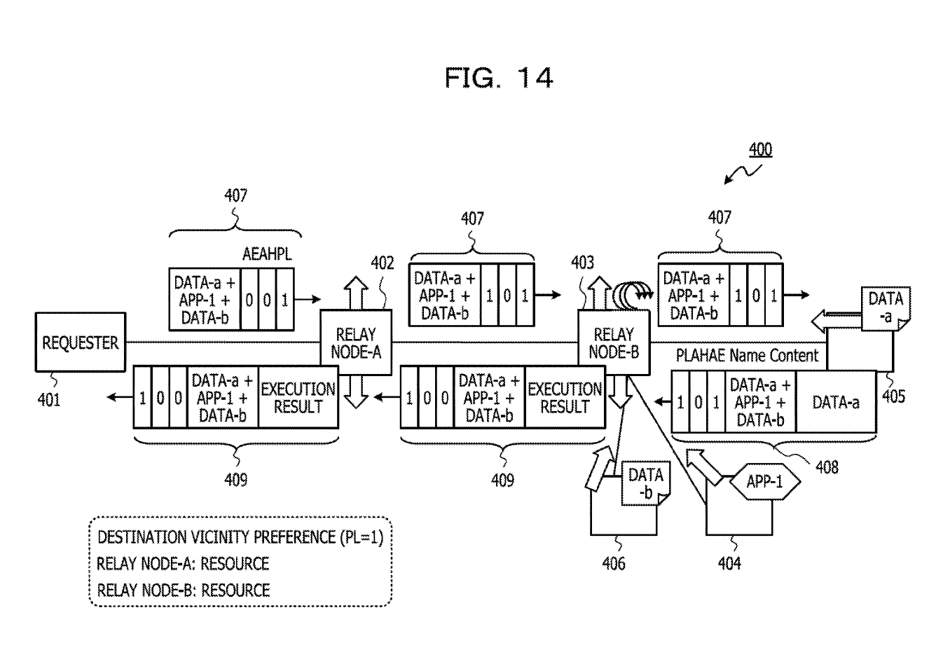

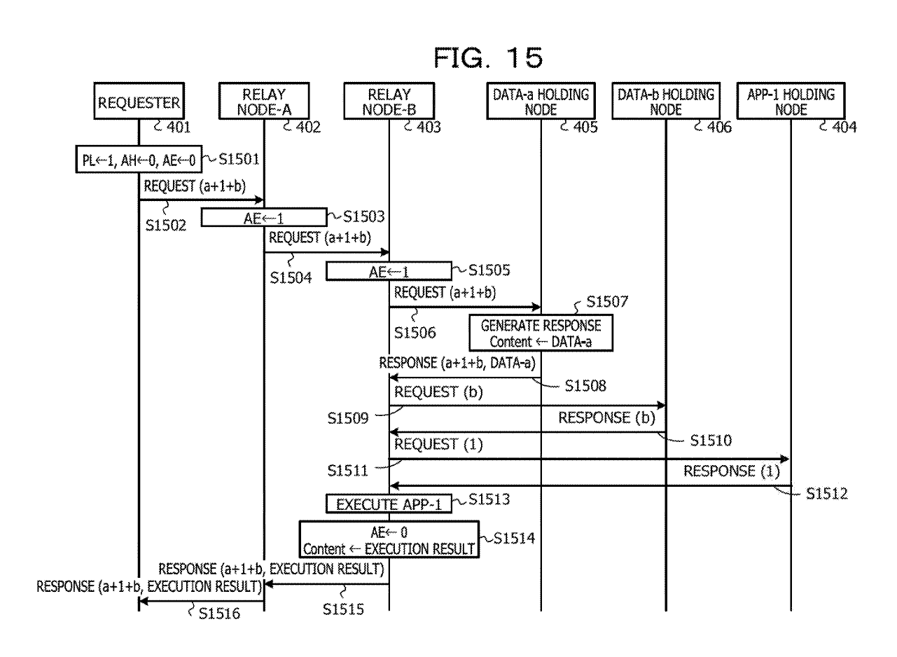

Next, a third operation example of the first embodiment will be described with reference to the explanatory diagram of FIG. 14 and the sequence diagram of FIG. 15. The third operation example illustrated in FIGS. 14 and 15 is an example of a case in which 1 is set in the execution policy bit PL and both of the relay node-A 402 and the relay node-B 403 have the resource for executing the application. A simple notation method in FIG. 15 is the same as that of the first operation example of FIG. 11.

First, the requester 401 performs the following control operation according to the above-described <Operation Pattern 1>. As in the case of the first operation example of FIGS. 4 and 11, the third operation example of FIGS. 14 and 15 is, for example, a case in which the application to be executed is “the output data<Σ (the input data)” as in the image analysis application or the sensor data analysis application. As a result, referring to the PL setting table of FIG. 9, the requester 401 sets the value 1 indicating the destination vicinity preference in the execution policy bit PL of the request message 407 to be transmitted. Then, the requester 401 sets the name “Data-a+App-1+Data-b” as the name portion of the request message 407 (until now, S1501 of FIG. 15). Then, the requester 401 transmits the request message 407 generated in this way to the relay node-A 402 (S1502 of FIG. 15).

Each of the relay node-A 402 and the relay node-B 403 on a path reaching the destination node executes the message transmission process according to <Operation Pattern 2>, <Operation Pattern 3>, or <Operation Pattern 4> described above in the description of the first operation example.

In the third operation example of FIG. 14, the relay node-A 402 does not have no “App-1” and has a resource for the execution. Therefore, the relay node-A 402 turns on the application executable bit AE in the request message 407 according to the above-described <Operation Pattern 3>. The relay node-A 402 stores the setting of AE=1 and the first setting of AE=1 in the request message 407 in the memory 702 (FIG. 7) (until now, S1503 of FIG. 15). Then, the relay node-A 402 transmits the request message 407 to the relay node-B 403 (S1504 of FIG. 15).

Subsequently, the relay node-B 403 holds no “App-1” and has the resource for the execution as in the relay node-A 402. Therefore, the following operation is performed according to the above-described <Operation Pattern 3>. First, the relay node-B 403 also overwrites the application executable bit AE in the request message 407. In this case, since the bit of the AE of the received request message 407 is already the value 1, the state is not changed. The relay node-B 403 stores setting of AE=1 in the request message 407 in the memory 702 (FIG. 7). The bit of the AE of the received request message 407 is already the value 1. Therefore, the relay node-B 403 does not store the first setting of AE=1 (until now, S1505 of FIG. 15). Then, the relay node-B 403 transmits the request message 407 to the Data-a holding node 405 (S1506 of FIG. 15).

The Data-a holding node 405 has neither “App-1” nor the resource for the execution and the application executable bit AE of the request message 407 is turned on. Therefore, as in the case of the first operation example of FIG. 4 or the like, the following operation is performed according to the above-described <Operation Pattern 6>. The Data-a holding node 405 copies the bit values of the PL, AH, and AE of the request message 407 in the header portion. Then, the Data-a holding node 405 generates the response message 408 in which the “Data-a” body is stored in the content portion (S1507 of FIG. 15). Then, the Data-a holding node 405 transmits the generated response message 408 to the relay node-B 403 (S1508 of FIG. 15).

The relay node on the path along which the response message 408 or 409 is received from the Data-a holding node 405 performs the transmission process/the application execution process of the response message 408 or 409 according to <Operation Pattern 8> or <Operation Pattern 9> described above in the description of the first operation example.

When the response message 408 arrives at the relay node-B 403, the execution policy bit PL=1 is set and the application executable bit AE is turned on. The relay node-B 403 stores setting of AE=1 in the memory 702. Therefore, the relay node-B 403 determines to execute “App-1” according to the above-described <Operation Pattern 8> as in the case of the first operation example of FIG. 4. As a result, the relay node-B 403 performs the series of control operations from S1509 to S1515 of FIG. 15 as in the series of operations from S1108 to S1114 of the first operation example of FIG. 11. The relay node-B 403 acquires “App-1”, “Data-a”, and “Data-b” and performs the application execution. The relay node-B 403 generates the response message 409 in which the AE (and the AH) bit is reset to 0 and the application execution result is stored in the content portion and relays the response message 409 to the relay node-A 402.

The relay node-A 402 has the resource for executing “App-1”, but “App-1” has already been executed by the relay node-B 403. In this state, both of the application holding bit AH and the application executable bit AE of the header portion of the received response message 409 are turned off. Accordingly, the relay node-A 402 relays the received response message 409 to the requester 401 without change according to the above-described <Operation Pattern 9> (S1516 of FIG. 15).

Finally, the requester 401 receives the execution result of the application from the content portion of the received response message 409.

In this way, in the third operation example of FIGS. 14 and 15, the execution policy bit PL=1 (destination vicinity preference) is designated when the requester 401 transmits the request message 407. Therefore, of the relay node-A 402 and the relay node-B 403 having the resource for executing “App-1”, the relay node-B 403 closer to the Data-a holding node 405 which is the destination node executes “App-1”.

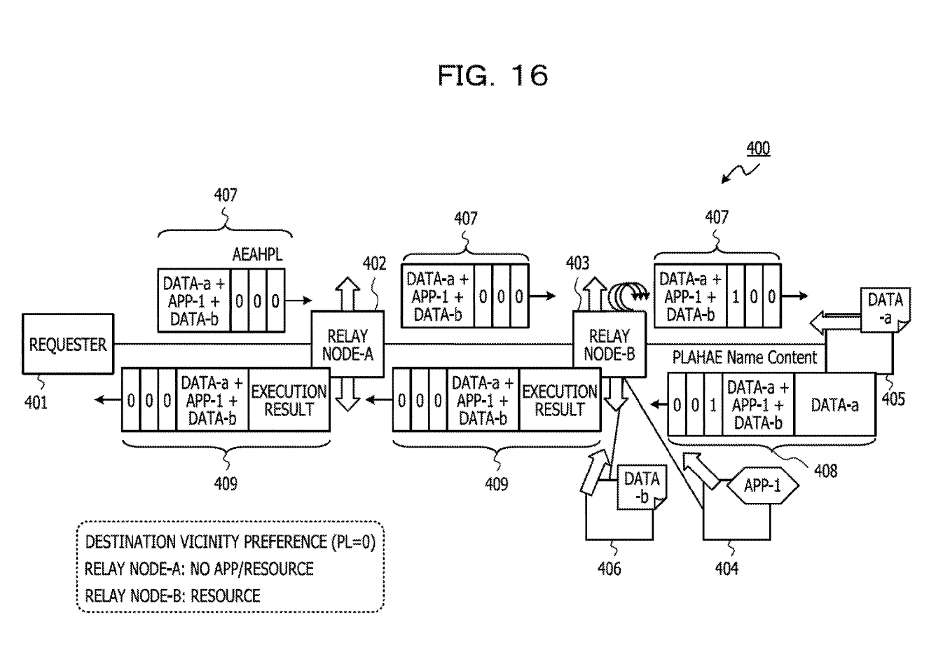

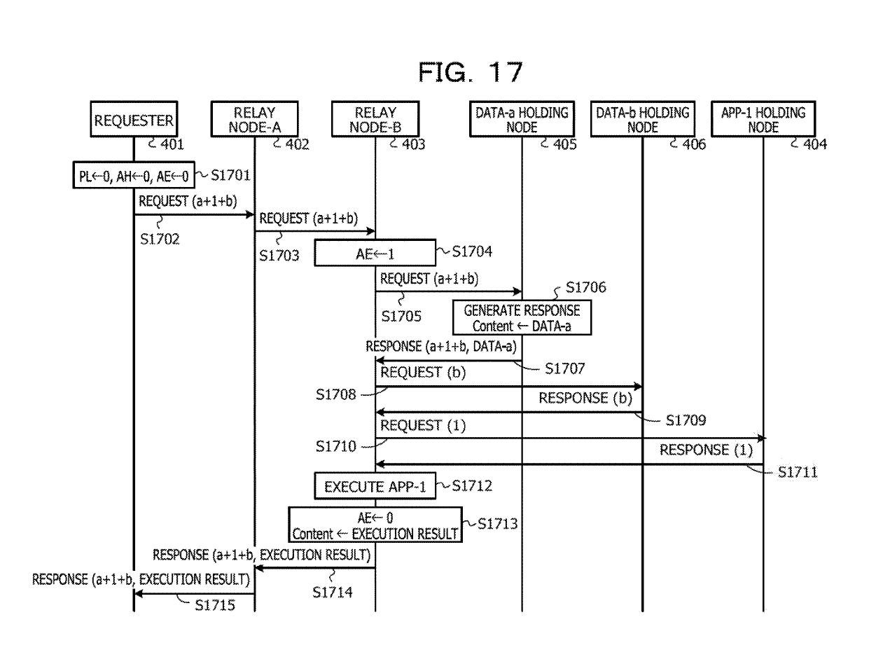

Next, a fourth operation example of the first embodiment will be described with reference to the explanatory diagram of FIG. 16 and the sequence diagram of FIG. 17. The fourth operation example illustrated in FIGS. 16 and 17 is an example of a case in which 0 is set in the execution policy bit PL and only the relay node-B 403 has the resource for executing the application. A simple notation method in FIG. 17 is the same as that of the first operation example of FIG. 11.

First, the requester 401 performs the following control operation according to the above-described <Operation Pattern 1>. The fourth operation example of FIGS. 16 and 17 is, for example, a case in which the application to be executed is “the output data>Σ (the input data)” as in the map searching application. As a result, referring to the PL setting table of FIG. 9, the requester 401 sets the value 0 indicating the vicinity of the requester in the execution policy bit PL of the request message 407 to be transmitted. Then, the requester 401 sets the name “Data-a+App-1+Data-b” as the name portion of the request message 407 (until now, S1701 of FIG. 17). Then, the requester 401 transmits the request message 407 generated in this way to the relay node-A 402 (S1702 of FIG. 17).

Each of the relay node-A 402 and the relay node-B 403 on a path reaching the destination node executes the transmission process for the request message 407 according to <Operation Pattern 2>, <Operation Pattern 3>, or <Operation Pattern 4> described above in the description of the first operation example.

In the fourth operation example of FIGS. 16 and 17, the series of control operations from S1703 to S1707 of FIG. 17 in the relay node-A 402, the relay node-B 403, and the Data-a holding node 405 are the same as the series of operations from S1103 to S1107 of the first operation example of FIG. 11.

The relay node on the path along which the response message 408 is received from the Data-a holding node 405 performs the transmission process and/or the application execution process of the response message 408 or 409 according to <Operation Pattern 8> or <Operation Pattern 9> described above in the description of the first operation example.

In this case, the relay node-B 403 receiving the response message 408 performs the same series of operations from S1108 to S1114 of the first operation example of FIG. 11 as the series of operations from S1708 to S1714 of FIG. 17. The relay node-B 403 acquires “App-1”, “Data-a”, and “Data-b” and performs the application execution. The relay node-B 403 generates the response message 409 in which the AE (and the AH) bit is set to 0 and the application execution result is stored in the content portion and relays the response message 409 to the relay node-A 402.

The relay node-A 402 transmits the response message 409 to the requester 401 without change according to the above-described <Operation Pattern 9> as in the case of the first operation example of FIG. 4 since AH=0 and AE=0 are set in the received response message 409 (S1715 of FIG. 17).

Finally, the requester 401 receives the execution result of the application from the content portion of the received response message 409.

In this way, in the fourth operation example of FIGS. 16 and 17, the execution policy bit PL=0 (requester vicinity preference) is designated when the requester 401 transmits the request message 407. However, any relay node does not hold “App-1” and the relay node having the resource for executing “App-1” is only the relay node-B 403. Accordingly, although the relay node-B 403 is a relay node distant from the requester 401, the relay node-B 403 capable of uniquely executing “App-1” executes “App-1”.

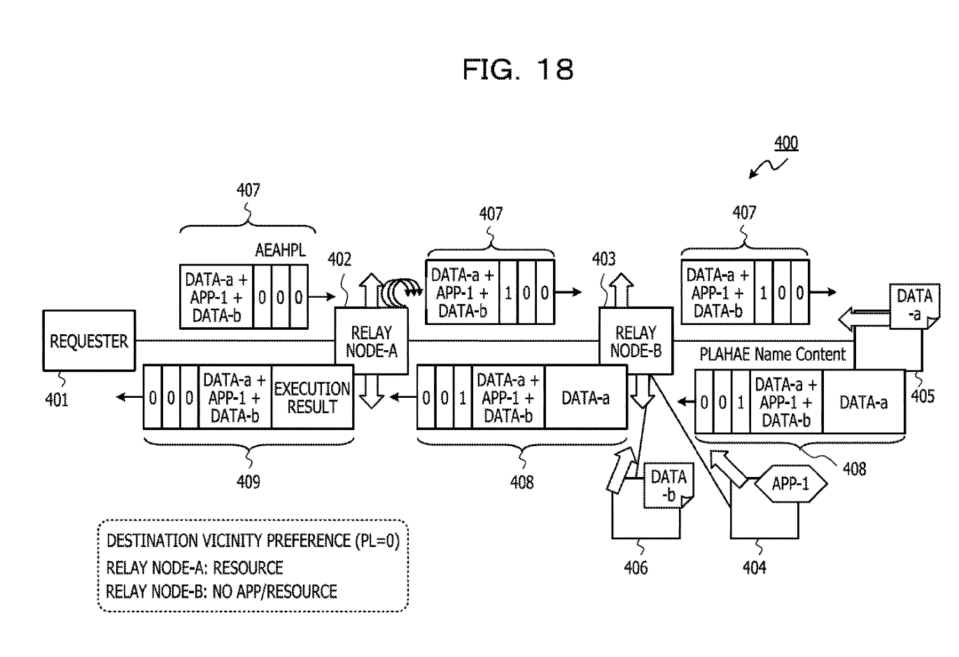

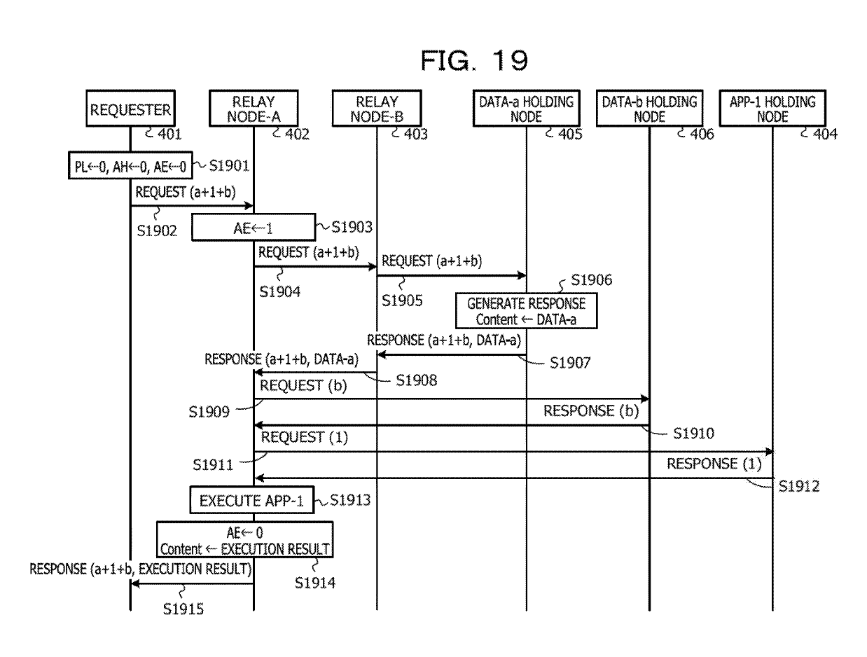

Next, a fifth operation example of the first embodiment will be described with reference to the explanatory diagram of FIG. 18 and the sequence diagram of FIG. 19. The fifth operation example illustrated in FIGS. 18 and 19 is an example of a case in which 0 is set in the execution policy bit PL and only the relay node-A 402 has the resource for executing the application. A simple notation method in FIG. 19 is the same as that of the first operation example of FIG. 11.

First, the requester 401 performs the following control operation according to the above-described <Operation Pattern 1>. As in the case of the fourth operation example of FIG. 16, the fifth operation example of FIG. 18 is, for example, a case in which the application to be executed is “the output data>Σ (the input data)” as in the map searching application. As a result, referring to the PL setting table of FIG. 9, the requester 401 sets the value 0 indicating the vicinity of the requester in the execution policy bit PL of the request message 407 to be transmitted. Then, the requester 401 sets the name “Data-a+App-1 +Data-b” as the name portion of the request message 407 (until now, S1901 of FIG. 19). Then, the requester 401 transmits the generated request message 407 to the relay node-A 402 according to the above-described <Operation Pattern 1> (S1902 of FIG. 19).

Each of the relay node-A 402 and the relay node-B 403 on a path reaching the destination node executes the transmission process for the request message 407 according to <Operation Pattern 2>, <Operation Pattern 3>, or <Operation Pattern 4> described above in the description of the first operation example.

In the fifth operation example of FIGS. 18 and 19, the series of control operations from S1903 to S1907 in the relay node-A 402, the relay node-B 403, and the Data-a holding node 405 are the same as the series of operations from S1303 to S1307 of the second operation example of FIG. 13.

The relay node on the path along which the response message 408 is received from the Data-a holding node 405 performs the transmission process and/or the application execution process of the response message 408 or 409 according to <Operation Pattern 8> or <Operation Pattern 9> described above in the description of the first operation example.

The relay node-B 403 has neither the application designated in the name portion of the response message 408 by the self-node including the vicinity nor the resource for the execution although the PL=0 and AE=1 are set in the received response message 409. Accordingly, the relay node-B 403 transmits the response message 408 to the relay node-A 402 without change according to the above-described <Operation Pattern 9> (S1908 of FIG. 19).

The relay node-A 402 performs the series of operations from S1909 to S1915 of FIG. 19 as in the series of operations from S1309 to S1315 of the second operation example of FIG. 13. The relay node-A 402 acquires “App-1”, “Data-a”, and “Data-b” and performs the application execution. The relay node-A 402 generates the response message 409 in which the AE (and the AH) bit is reset to 0 and the application execution result is stored in the content portion and relays the response message 409 to the requester 401.

Finally, the requester 401 receives the execution result of the application from the content portion of the received response message 409.

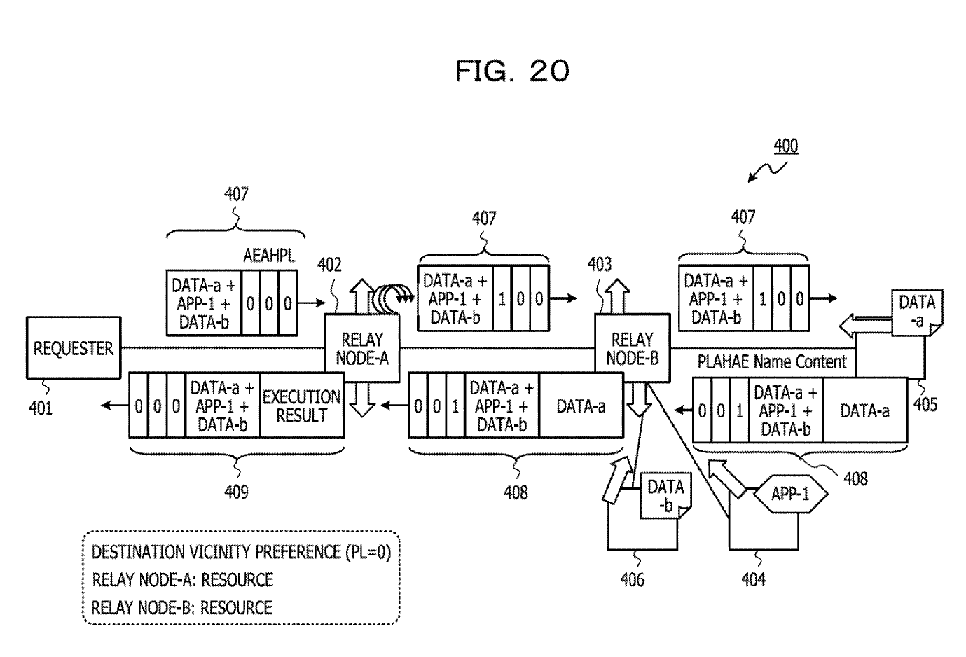

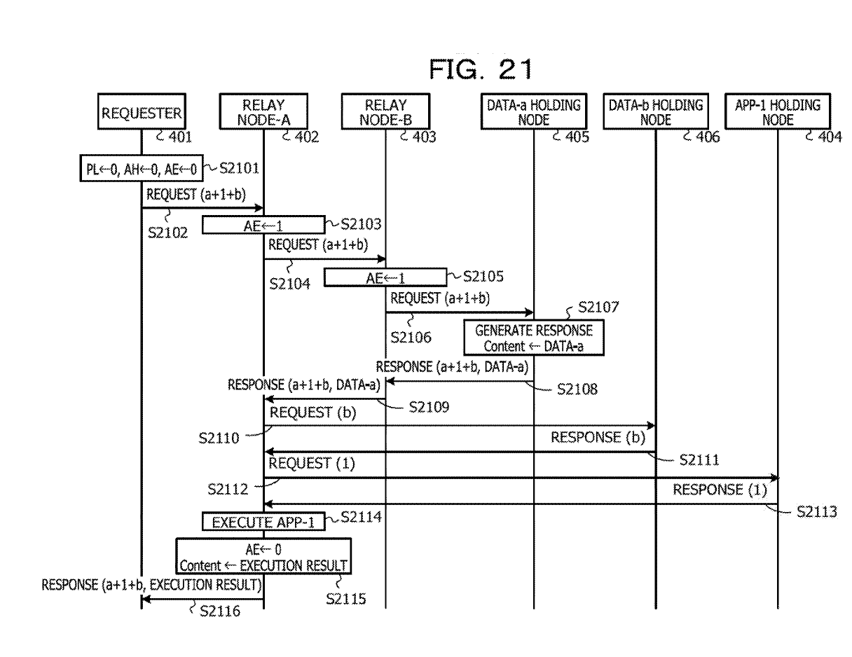

Next, a sixth operation example of the first embodiment will be described with reference to the explanatory diagram of FIG. 20 and the sequence diagram of FIG. 21. The sixth operation example illustrated in FIGS. 20 and 21 is an example of a case in which 0 is set in the execution policy bit PL and both of the relay node-A 402 and the relay node-B 403 have the resource for executing the application. A simple notation method in FIG. 21 is the same as that of the first operation example of FIG. 11.

First, the requester 401 performs the following control operation according to the above-described <Operation Pattern 1>. As in the case of the fourth operation example of FIG. 16, the sixth operation example of FIGS. 20 and 21 is, for example, a case in which the application to be executed is “the output data<Σ (the input data)” as in the map searching application. As a result, referring to the PL setting table of FIG. 9, the requester 401 sets the value 0 indicating the request vicinity preference in the execution policy bit PL of the request message 407 to be transmitted. Then, the requester 401 sets the name “Data-a+App-1+Data-b” as the name portion of the request message 407 (until now, S2101 of FIG. 21). Then, the requester 401 transmits the request message 407 generated in this way to the relay node-A 402 (S2102 of FIG. 21).

Each of the relay node-A 402 and the relay node-B 403 on a path reaching the destination node executes the transmission process for the request message 407 according to <Operation Pattern 2>, <Operation Pattern 3>, or <Operation Pattern 4> described above in the description of the first operation example.

In the sixth operation example of FIGS. 20 and 21, the series of control operations from S2103 to S2108 in the relay node-A 402, the relay node-B 403, and the Data-a holding node 405 are the same as the series of operations from S1503 to S1508 of the third operation example of FIG. 15.

The relay node on the path along which the response message 408 is received from the Data-a holding node 405 performs the transmission process and/or the application execution process of the response message 408 or 409 according to <Operation Pattern 8> or <Operation Pattern 9> described above in the description of the first operation example.

When the relay node-B 403 receives the response message 408 from the Data-a holding node 405, PL=0 and AE=1 are set and the relay node-B 403 stores setting of AE=1 in the memory 702. However, the relay node-B 403 does not store first setting of AE=1 in the memory 702. Accordingly, the relay node-B 403 transmits the response message 408 to the relay node-A 402 without change according to the above-described <Operation Pattern 9> (S2109 of FIG. 21).

Next, when the relay node-A 402 receives the response message 408 from the relay node-B 403, PL=0 and AE=1 are set and the relay node-A 402 stores first setting of AE=1 in the memory 702. Accordingly, the relay node-A 402 determines to execute “App-1” according to the above-described <Operation Pattern 8>. As a result, the relay node-A 402 performs the series of operations from S2110 to S2116 of FIG. 21 as in the series of operations from S1309 to S1315 of the first operation example of FIG. 11. The relay node-A 402 acquires “App-1”, “Data-a”, and “Data-b” and performs the application execution. The relay node-A 402 generates the response message 409 in which the AE (and the AH) bit is reset to 0 and the application execution result is stored in the content portion and relays the response message 409 to the requester 401.

Finally, the requester 401 receives the execution result of the application from the content portion of the received response message 409.

In this way, in the sixth operation example of FIGS. 20 and 21, the requester 401 designates the execution policy bit PL=0 (the requester vicinity preference) at the time of transmitting the request message 407. Therefore, of the relay node-A 402 and the relay node-B 403 having the resource for executing “App-1”, the relay node-A 402 closer to the requester 401 executes “App-1”.

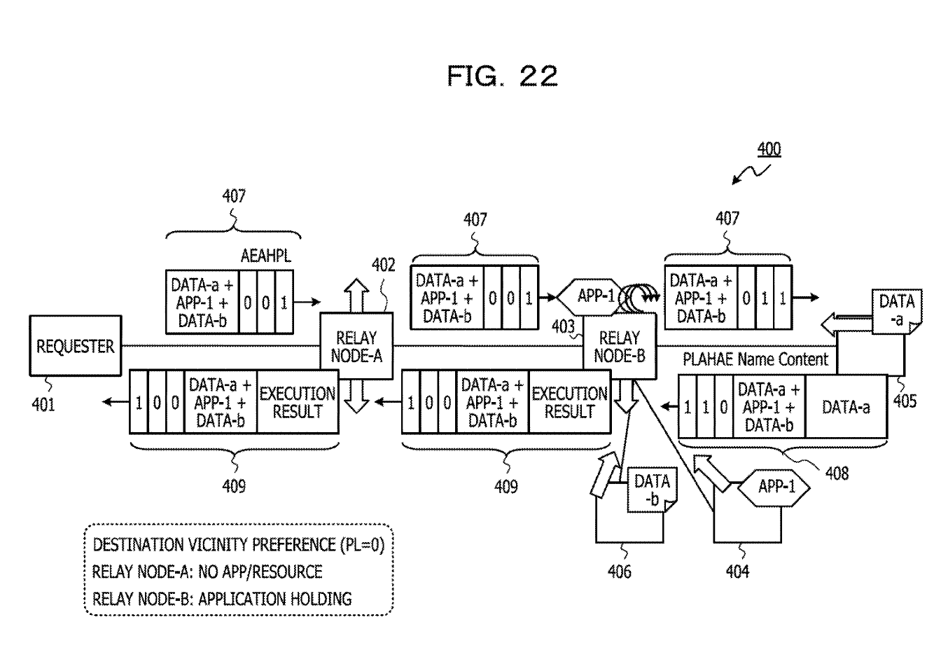

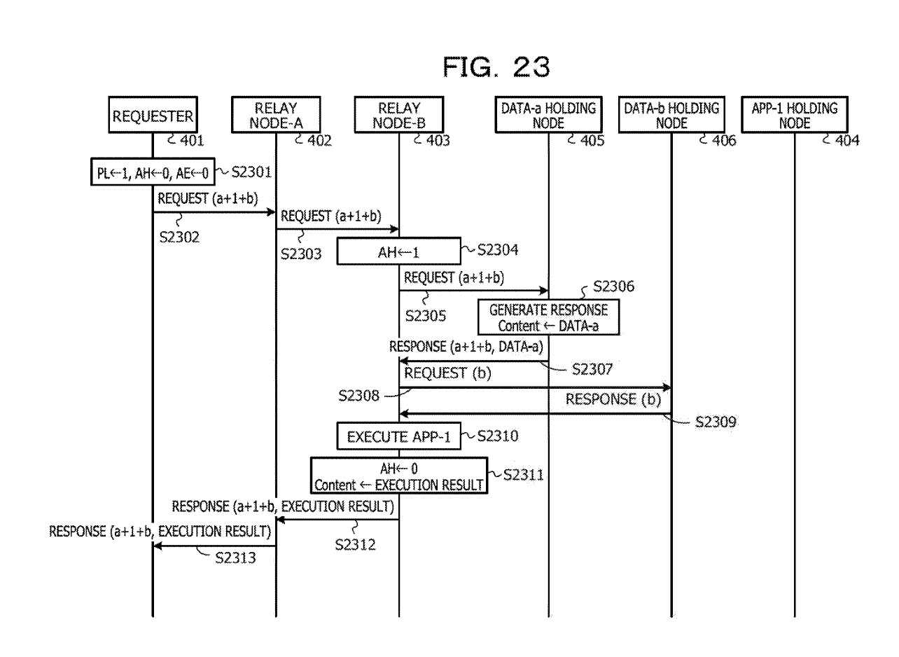

Next, a seventh operation example of the first embodiment will be described with reference to the explanatory diagram of FIG. 22 and the sequence diagram of FIG. 23. The seventh operation example illustrated in FIGS. 22 and 23 is an example of a case in which 1 is set in the execution policy bit PL, the relay node-A 402 does not hold the application and has no resource for executing the application, and the relay node-B 403 holds an application. A simple notation method in FIG. 23 is the same as that of the first operation example of FIG. 11.

First, the requester 401 performs the following control operation according to the above-described <Operation Pattern 1>. The seventh operation example of FIGS. 22 and 23 is, for example, a case in which the application to be executed is “the output data<Σ (the input data)” as in the image analysis application or the sensor data analysis application. As a result, referring to the PL setting table of FIG. 9, the requester 401 sets the value 1 indicating the requester vicinity preference in the execution policy bit PL of the request message 407 to be transmitted. Then, the requester 401 sets the name “Data-a +App-1+Data-b” as the name portion of the request message 407 (until now, S2301 of FIG. 23). Then, the requester 401 transmits the request message 407 generated in this way to the relay node-A 402 (S2302 of FIG. 23).

Each of the relay node-A 402 and the relay node-B 403 on a path reaching the destination node executes the transmission process of the request message 407 according to <Operation Pattern 2>, <Operation Pattern 3>, or <Operation Pattern 4> described above in the description of the first operation example.

In the seventh operation example of FIGS. 22 and 23, the relay node-A 402 has neither “App-1” which is the designated application nor the resource for the execution. Therefore, the relay node-A 402 relays the request message 407 to the relay node-B 403 while both the application holding bit AH and the application executable bit AE of the request message 407 remains to be 0 according to the above-described <Operation Pattern 4> (S2303 of FIG. 23).

Next, since the relay node-B 403 holds “App-1”, the application holding bit AH in the request message 407 is returned on according to the above-described <Operation Pattern 2>. The relay node-B 403 stores setting of AH=1 and first setting of AH=1 in the memory 702 (until now, S2304 of FIG. 23). Then, the relay node-B 403 transmits the request message 407 to the Data-a holding node 405 (S2305 of FIG. 23).

The Data-a holding node 405 has neither “App-1” nor the resource for the execution and the application holding bit AH of the request message 407 is turned on. Therefore, as in the case of the first operation example of FIG. 4 or the like, the following operation is performed according to the above-described <Operation Pattern 6>. The Data-a holding node 405 copies the bit values of the PL, AH, and AE of the request message 407 in the header portion and generates the response message 408 in which the “Data-a” body is stored in the content portion (S2306 of FIG. 23). Then, the Data-a holding node 405 transmits the generated response message 408 to the relay node-B 403 (S2307 of FIG. 23).

The relay node on the path along which the response message 408 or 409 is received from the Data-a holding node 405 performs the transmission process/the application execution process of the response message 408 or 409 according to <Operation Pattern 8> or <Operation Pattern 9> described above in the description of the first operation example.

When the response message 408 arrives at the relay node-B 403, the execution policy PL bit=1 is set, the application holding bit AH is turned on, and the relay node-B 403 stores the setting of AH=1 in the memory 702. Therefore, the relay node-B 403 determines to execute “App-1” according to the above-described <Operation Pattern 8>. As a result, the relay node-B 403 first generates another request message in which the name “Data-b” corresponding to one of the element objects not held by the self-node is stored in the name portion. Then, the relay node-B 403 transmits the request message to the network (S2308 of FIG. 23). The Data-b holding node 406 transmits the response message in which the “Data-b” body is stored in the content portion to the relay node-B 403 in response to the other request message (S2309 of FIG. 23). “App-1” is held in the relay node-B 403. Therefore, the relay node-B 403 does not request “App-1” from the application holding node 404. Thereafter, the relay node-B 403 extracts the “Data-a” body stored in the response message 408 since the setting of AH=1 is stored. Then, the relay node-B 403 executes a program indicated by the “App-1” body for which the self-node holds “Data-a” and “Data-b” as input data (S2310 of FIG. 23). As a result, the relay node-B 403 resets the application holding bit AH in the header portion to 0 (the application executable bit AE is originally 0). Then, the relay node-B 403 newly generates the response message 409 in which the execution result is stored in the content portion (S2311 of FIG. 23). The reason why AH=0 is set is that another node does not execute an application. Then, the relay node-B 403 transmits the response message 409 to the relay node-A 402 (S2312 of FIG. 23).

The relay node-A 402 has neither “App-1” nor the resource for the execution. Therefore, the relay node-A 402 relays the received response message 409 without change to the requester 401 according to the above-described <Operation Pattern 9> (S2313 of FIG. 23).

Finally, the requester 401 receives the execution result of the application from the content portion of the received response message 409.

In this way, in the seventh operation example of FIGS. 22 and 23, the requester 401 designates the execution policy bit PL=1 (the destination vicinity preference) at the time of transmitting the request message 407. Therefore, of the relay node-A 402 and the relay node-B 403 having the resource for executing “App-1”, the relay node-B 403 closer to the Data-a holding node 405 which is the destination node executes “App-1”.

Next, a detailed operation of the second embodiment described above with reference to FIG. 5 will be described below.

In the communication system 400 in FIG. 5 according to the second embodiment, the requester 401 accesses the “App-1” holding node 404, the Data-a holding node 405, and the Data-b holding node 406 via a network. Although not illustrated in FIG. 5, either the relay node-A 402 or the relay node-B 403 are actually operating even in the second embodiment, as illustrated in FIG. 6.

In the communication system 400 according to the second embodiment, as illustrated in FIG. 5, as an initial state, the “App-1” body is disposed in “App-1” holding node 404, the “Data-a” body is disposed in the Data-a holding node 405, and the “Data-b” body is disposed in the Data-b holding node 406. In order for the relay node-A 402 or the relay node-B 403 described in the first embodiment to execute the application, these element objects held in the above-described holding nodes are acquired as indispensable and the application is executed using the element objects.

As described above, the hardware configuration of the application holding node 404, the Data-a holding node 405, and the Data-b holding node 406 is the hardware configuration example illustrated in FIG. 7.

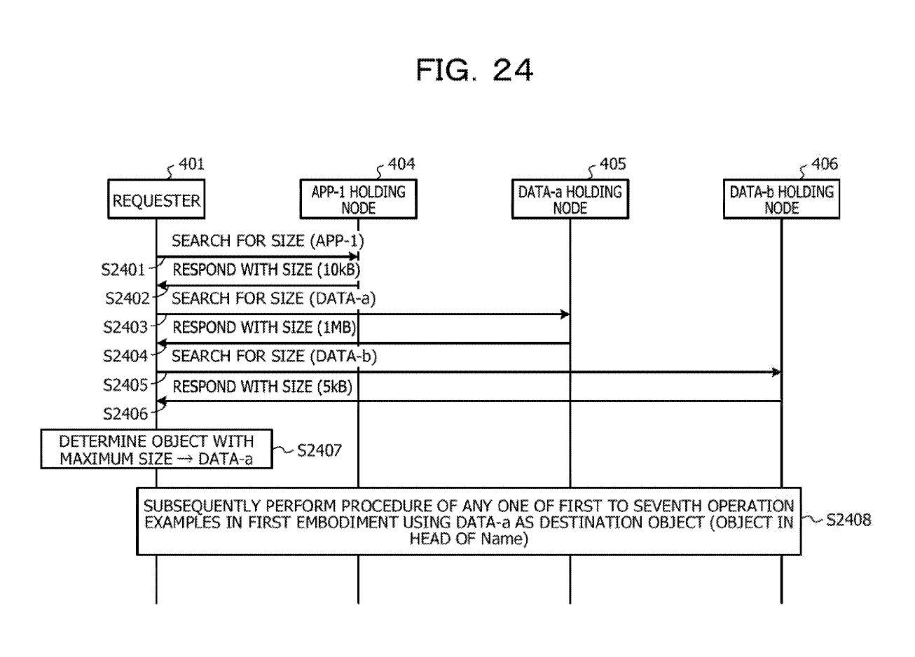

A detailed operation of the communication system 400 according to the second embodiment will be described with reference to the sequence diagrams of FIGS. 5 and 24.

The requester 401 or the edge node searches for the sizes of the element objects indispensable to execute the application in the application holding node 404, the Data-a holding node 405, and the Data-b holding node 406 by a predetermined communication protocol (501 of FIG. 5). As the predetermined communication protocol, Hyper Text Transfer Protocol (HTTP), Telnet, File Transfer Protocol (FTP), or the like can be used.

Specifically, the requester 401 first transmits a command of the predetermined communication protocol by which the size of “App-1” held by the application holding node 404 is searched for in the application holding node 404 (S2401 of FIG. 24). Then, the application holding node 404 responds with the size of “App-1”, for example, 10 kB, to the requester 401 (S2402 of FIG. 24).

The requester 401 transmits a command of the predetermined communication protocol by which the size of “Data-a” held by the Data-a holding node 405 is searched for in the Data-a holding node 405 (S2403 of FIG. 24). Then, the Data-a holding node 405 responds with the size of “Data-a”, for example, 1 MB, to the requester 401 (S2404 of FIG. 24).

Similarly, the requester 401 transmits a command of the predetermined communication protocol by which the size of “Data-b” held by the Data-b holding node 406 is searched for in the Data-b holding node 406 (S2405 of FIG. 24). Then, the Data-b holding node 406 responds with the size of “Data-b”, for example, 5 kB, to the requester 401 (S2406 of FIG. 24).

Thereafter, the requester 401 compares the sizes acquired from the pieces of response data to each other. Then, the requester 401 determines, for example, Data-a” as the element object with the maximum size (hereinafter referred to as a specific object) (S2407 of FIG. 24).

Alternatively, when a size relation between the application and the data can be known in advance from the property of the application, a maximum object may defined statically for each type of application additionally in the PL setting table described above in FIG. 9.

The requester 401 links a name character string of the element objects (the application and the data) indispensable to execute the application by “+”, as described above in the description of FIG. 8A and sets the name character string in the name portion of the request message 407. As described above, for example, the name portion is notated as “Data-a+App-1+Data-b”. “Data-a+App-1+Data-b” notated in the name portion is the names of the element objects. The request message 407 is routed in a network using the node (the Data-a holding node 405 illustrated in 502 in the case of FIG. 5) which holds the element object corresponding to the name in the head of the name portion (“Data-a” in the case of FIG. 5) as a destination node.

After the request message 407 is transmitted to the network, the procedure of any one of the first to seventh operation examples described above in the first embodiment is performed.

In the communication system according to the above-described first or second embodiment, it is possible to reduce a transmission delay bandwidth of the application or the data and quicken a response to the application execution result. Load balance of the application execution process in the network is realized. Thus, it is possible to achieve efficient use of the resources indispensable to execute the application.

Next, a third embodiment will be described with reference to the drawings. As described above, the first embodiment is applied in a case in which the pieces of dominant input data, that is, the number of pieces of input data with a relatively large size, is 1, and is a scheme that causes an application to be executed at a position appropriate on a path reaching the input data from a requester.

In the first embodiment, the case in which the number of pieces of dominant input data is 1 has been described. On the other hand, in the third embodiment, a case in which the number of dominant data is plural is also considered. In the third embodiment to be described below, application execution locations are distributed to other NFN nodes. Thus, even when output data<Σ (input data) is satisfied, it is possible to reduce transmission delay of an application or the input data and shorten a response time. As described above, the response time means a time in which a user gives an application execution request and a response to the application execution request is received.

As described above, the third embodiment is applied in a case in which the number of pieces of dominant input data is plural and is a scheme of enabling an application to be executed at branch points (also referred to as branch point nodes) at positions appropriate on paths reaching the plurality of pieces of dominant input data from a requester. A case in which the number of pieces of dominant input data is plural refers to a case in which a plurality of pieces of input data among input data are each relatively larger than the pieces of other input data in size and the pieces of dominant input data have substantially equal sizes one other. The branch point refers to a node that has a plurality of pieces of dominant input data although the number of received request messages is 1 and transmits a plurality of request messages to a plurality of nodes which are destinations.

In general, a network is large-scale and it is difficult to perform centralized management on all the node state in real time at one spot. Target “applications” include both network applications such as firewalls or filtering and user applications such as data analysis applications or image analysis applications. The applications are mounted in the forms of bytecodes (for example, Java (registered trademark)), are platform-independent, and are movable between nodes.

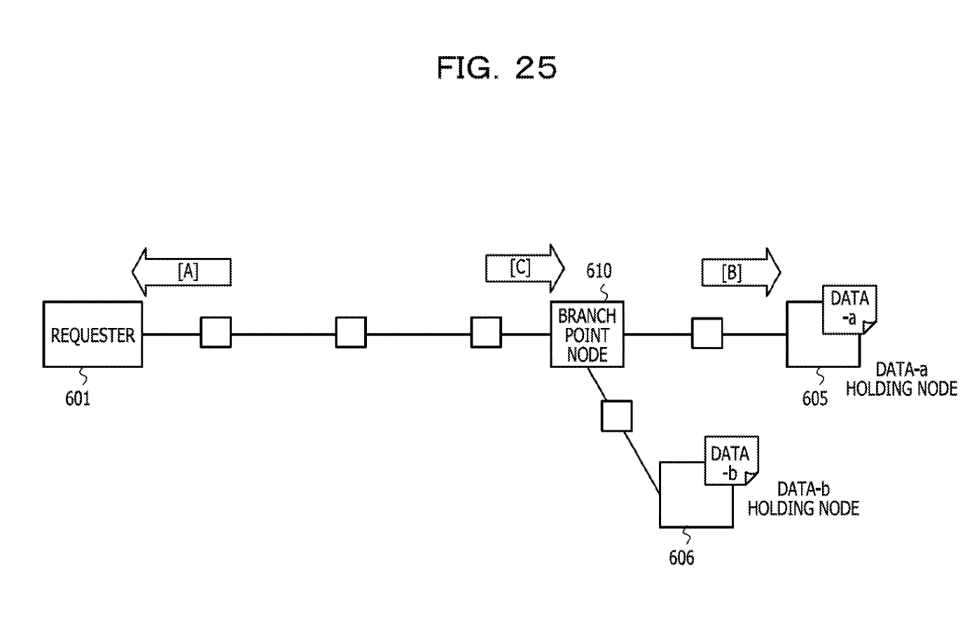

Therefore, tasks of the third embodiment is to shorten a response time in application execution calling in a network in a case in which the number of pieces of dominant input data is plural and to realize load sharing between nodes. To realize the tasks, as illustrated in FIG. 25, an application is considered to be executed in branch point nodes. In this case, here, the branch point node refers to a point at which a path headed for a holding node which holds Data-a and Data-b as object elements in an NFN that has a tree structure formed by paths from a requester 601 to nodes having request objects is branched. The NFN is formed as network that has a tree structure when the side of the requester 601 beforehand selects paths in advance from the requester 601 which is on an actual communication network and is a starting point to nodes in which there are request objects.

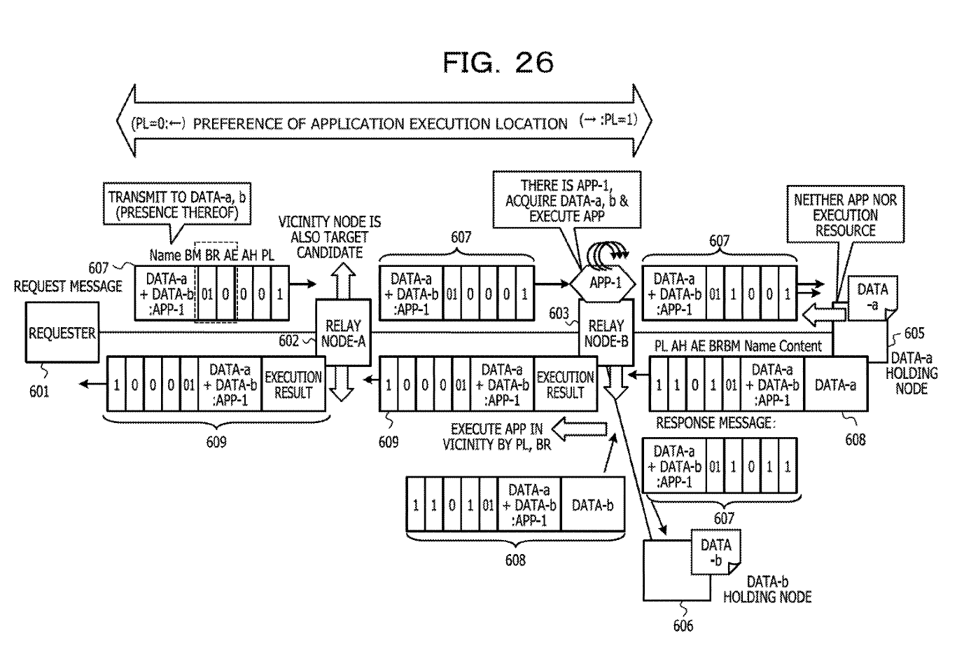

FIGS. 25 and 26 are diagrams illustrating networks to describe a basic policy of application execution. As illustrated in FIG. 26, an execution policy bit (P), an application execution holding bit (AH), and an application executable bit (AE) are included in advance in the request message 607, as in the first and second embodiments. In addition thereto, the request message 607 includes, for example, a 1-bit branch point bit (BR, branch point information) and a 2-bit branch mode bit (BM, branch mode information). By setting these bits, a network operation is decided as follows according to a relation between input and output data to and from an application:

[A] in a case in which the output data>Σ (the input data) is satisfied->an application is executed in the vicinity of a request node (PL=0, BM=Φ (don't care));

[B] in a case in which Σ (the input data)>the output data is satisfied and the number of pieces of dominant input data is 1->the application is executed in the vicinity of a node (distant from the request node) which has the input data, in the embodiment other than (PL=1 and BM=00); and

[C] in a case in which Σ (the input data)>the output data is satisfied and the number of pieces of dominant input data is plural->the application is executed in the vicinity of a branch point,

(a) in a case in which the application is not executed when all the input data is not included=>the application is executed in the vicinity of a first branch point (PL=1 and BM=01), and

(b) in a case in which the application can be executed with only some of the input data=>the application is executed in the vicinity of an individual branch point (PL=1 and BM=10).

Through the network operation, the application can be executed even in the branch point node 610 in addition to the case of the “App-1” holding node or the requester 601 which is the destination node.

In the third embodiment, it is possible to reflect a resource state of each node in decision of application execution locations and it is possible to realize load sharing between nodes centering on a specific location including a branch point. That is, it is possible to determine whether to execute an application from information locally obtained by each node according to the property of the application and a resource state of each node and it is possible to dynamically decide the application execution location.

As will be described below in detail, a policy according to the third embodiment using the network operation illustrated in FIG. 26 will be described simply. FIG. 26 illustrates a case in which App-1, Data-a, and Data-b are indispensable to execute the application. A procedure is as follows.

The request message 607 includes a branch point bit (BR) and a branch mode bit (BM) in addition to the execution policy bit (PL)/the application holding bit (AH)/the application executable bit (AE).

According to the property of the application (a relation between an input data amount and an output data amount), the requester 601 or an edge node (at an entrance of a network which accommodates the requester) sets the execution policy bit PL and the branch mode bit of the request message 607.

The execution policy bit is selected from vicinity preference (PL=1) of the branch point node 610 and the vicinity preference (PL=0) of the requester 601 by the destination node.

The branch mode bit is selected and set from non-branch point (BM=00), application execution at the first branch point (BM=01), and application execution at an individual branch point (BM=10).

The request message 607 in the example illustrated in FIG. 26 preferentially indicates execution of the application (PL=1) and execution of the application (BM=01) at the first branch point near a holding node of an application/application execution resource which is the destination node or the branch point. The request message configured to indicate the plurality of pieces of dominant input data is transmitted to the destination indicated by the name portion of the request message 607.

In FIG. 26, Data-a and Data-b are destinations. Nodes on a path also include nearby nodes which are not on the path and the application holding bit (AH) and/or the application executable bit (AE) are sequentially set according to whether a designated application is included or an execution resource is included. In locations (branch points) relaying the request message 607 to a plurality of network interfaces of the nodes on the path, the application execution in the nodes after the branch point bit BR is set is suppressed.

When each node determine the bit states of the request message and the response message and decide an operation, the application execution location is decided in a preferential order of a node on the path, a node close to the path, and a node in the vicinity of the path. Here, the node on the path refers to an application/application execution resource holding node of the destination node, the requester or the edge node, or a branch point node. The node close to the path refers to any node disposed nearby among an application/application execution resource holding node of the destination node and on the road, the requester or the edge node, and the branch point node. At the time of decision performed through the application execution by the node on the path, one node of the application/application execution resource holding node of the destination node, the requester 607 or the edge node, and the branch point node 610 is decided as the application execution location. The node executing the application acquires an application and data indispensable in the location, performs application execution, and returns a result of the application execution as a response message. In a case in which the application is executed at the branch point and there are a plurality of branch points, the application is executed at one branch point or for each branch point according to a setting value of the branch mode bit BR. In this way, each node knows a relative position of the node on the path by the AH, AE, and BR bits of the request message and the response message. Each node decides whether to execute the application in consideration of these bits, the PL bit, and the BM bit.

FIG. 26 illustrates a case in which the relay node-B 603 which is the branch point node 610 to Data-a and Data-b performs application execution. In this way, in the third embodiment, the node on the path (the application/application execution resource holding node of the destination node, the requester 601 or the edge node, or the branch point node 610), the node close to the path, and the node in the vicinity of the path executes the application according to the property of the application and the resource state of each node. That is, the node (which is not limited to a specific node) in which there is the application execution resource including the path or the vicinity of the path executes the application.

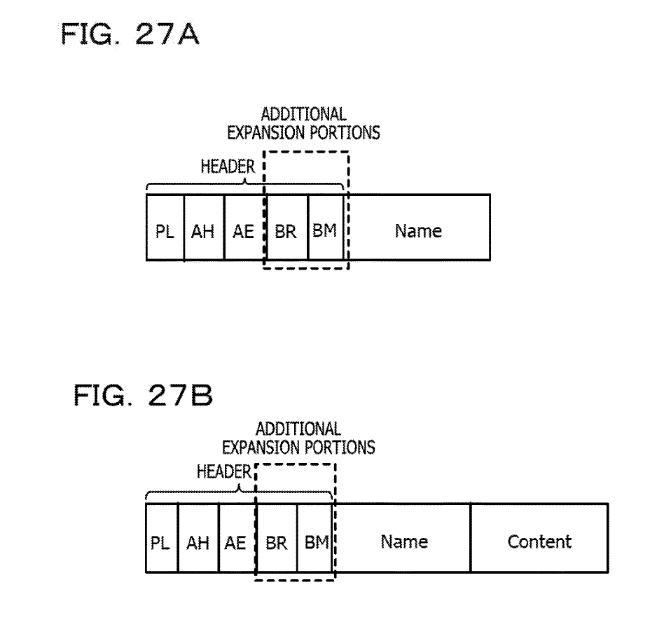

Next, the network operation of FIG. 26 will be described in detail using message formats of FIGS. 27A and 27B. FIGS. 27A and 27B are diagrams illustrating message formats of the request message and the response message in the following example (Parts 1 and 2).

As illustrated in FIG. 27A, the request message includes a header portion (PL, AH, AE, BR, BM) and a name portion. In the case of the network operation of FIG. 26, (PL, AH, AE, BR, BM)=(1, 0, 0, 0, 01) is set. The description there of will be made below. Additional expansion portions from the request message according to the first and second embodiment are BR and BM.

The PL (an execution bit, Policy) is a bit that takes a value 0 or 1. From the viewpoint of delay or a transmission amount, the PL indicates whether it is advantageous to execute a target application in the vicinity of a requester (PL=0) or it is advantageous to execute the target application in a location distant from the requester (=an application or data, or the vicinity of a branch point) (PL=1). When the requester transmits the request message or an edge node (a node which accommodates the requester and is at the entrance of a network) relays the request message, the PL is set according to the property of the application.

In a case in which an input data amount<an output data amount is satisfied in the application (for example, simple merging of data), the PL=0 is set. Conversely, in a case in which the input data amount>the output data amount is satisfied in the application (for example, image analysis), the PL=1 is set.

Since PL=1 is set in the network operation of FIG. 26, the application execution in a location distant from the requester 601 is selected.

The AH (an application holding bit AppHold) is a bit takes 0 or 1, is the same as the AH according to the above-described first and second embodiments, and indicates whether a self-node does not have an application designated in the name portion (AH=0) or has the application (AH=1). The requester 601 first sets the AH according to the holding state of the application and transmits the AH. The requester 601 sets 1 when the node on the path (including the vicinity of the path) has a designated application, and does not change the value when the node does not have the designated application. In the network operation of FIG. 26, since the relay node-A 602 does not hold the application, there is no change from AH=0, but the relay node-B 603 holds the application. Therefore, the relay node-B 603 changes the request message 607 from (PL, AH, AE, BR, BM)=(1, 0, 0, 0, 01) to (1, 1, 0, 1, 01) and transmits the request message 607 to a subsequent data holding node.

The AE (an application executable bit, AppExec) indicates that each node has a resource (for example, a combination of a CPU and a memory) with which an application is executed (AH=1) or does not have the resource (AH=0) as in the AE of the above-described first and second embodiments. The AE is a bit that takes a value 0 or 1. The requester 601 first sets the value of the AE according to a holding situation of an application execution resource of the self-node and transmits the request message 607. When the node on the path (including the vicinity of the path) has the execution resource, the node sets 1 in the AE. When the node does not have the execution resource, there is no change in the value.

An initial value of the BR (a branch bit, Branch) is 0 when the requester 601 transmits the request message 607. The BR is set to 1 by a node (the branch point node 610) relaying the request message 607 to the plurality of network interfaces. In the setting of BR=1 (and BM=01), the application execution is suppressed in the nodes (the nodes which are not branch point nodes) subsequent to the branch point node 610.

In the network operation of FIG. 26, the relay node-B 603 is the branch point node 610. Therefore, the relay node-B 603 updates the request message 607 from (PL, AH, AE, BR, BM)=(1, 0, 0, 0, 01) to (1, 1, 0, 1, 01), and thus there is a change to BR=1.

In the BM (a branch mode bit, Branch Mode), 2 bits representing a mode of a branching process are allocated. Specifically, BM=00 represents that the branching process is not performed, BM=01 represents that the application is executed at one point (first branch point), and BM=10 represents that the application is frequently executed at each branch point. The BM is set when the requester transmits a request message or the edge node relays the relay message from the property of the application. Since BM=01 is set in the network operation of FIG. 26, the application is executed at the first branch point, that is, the relay node-B 603.

The name portion is a field that has a variable length and designates execution of an application to be requested as in the cases of the above-described first and second embodiments. Element objects (an application and data) indispensable to execute the application are connected and displayed. For example, a plurality of pieces of data which are destinations of the request message are connected by “+” and applications indispensable to execute the application are connected by “.”. For example, as represented in the request message 607 of the network operation of FIG. 26, the name portion is represented as “Data-a+Data-b: App-1”. Data-a, Data-b, and App-1 are the names of objects. The name portion represents that Data-a and Data-b are input and App-1 is executed. The request message 607 is routed toward the data objects (in this case, Data-a and Data-b) indicated by the name portion.

Here, routing information corresponding to each element object is broadcasted in advance in the network from the presence location of each element object. Each node configures a routing table for the names of the element objects. Each node extracts the element objects of the name portion at the time of receiving the request message and routes the element objects to output interfaces corresponding to the element objects.

As illustrated in FIG. 27B, response messages 608 and 609 each include the header portion (PL, AH, AE, BR, and BM), the name portion, the content portion. The meanings of the portions other than a data portion are the same as those of the request message 607. Here, the AH, AE, BR, and BM are not set again, but are copied from the request message 607 in a destination node. The AH and AE are reset to 0 and are delivered to a subsequent node in a case in which the application is executed by a node which is halfway on the path. The BR is reset to 0 and is delivered to the subsequent node in a case in which the response message is relayed in the branch point node 610 (which is a node in which the BR is set in the request message 607). The response messages are routed by the name portion. Each node stores transmission sources of the request message 607 and transmits the response messages to the transmission sources.

The content portion is a field that has a variable length and stores an execution result of an application to be requested or element objects (the application and the data). After the application is executed in the node, the execution result of the application is inserted. Before the application is executed, the element objects are inserted.

In the network operation illustrated in FIG. 26, the Data-a holding node 605 does not have the application execution resource and holds Data-a. Therefore, the Data-a holding node 605 adds content of Data-a as a response message in addition to (PL, AH, AE, BR, BM)=(1, 1, 0, 1, 01). Similarly, a Data-b holding node 606 does not have the application execution resource and holds Data-b. Therefore, the Data-b holding node 606 adds content of Data-a as a response message in addition to (PL, AH, AE, BR, BM)=(1, 1, 0, 1, 01).

The relay node-B 603 which is the branch point is a first branch point node 610F that holds App-1 (AH=1) and stores the fact that the node updates the BR from 0 to 1. Since BM=01 is set, the first branch point node 610F performs the application execution using Data-a and Data-b, and thus the relay node-B 603 performs the application execution. After the application execution, the relay node-B 603 resets the values of the AH and BR from the original values to AH=0 and BR=0 and outputs (PL, AH, AE, BR, BM)=(1, 0, 0, 0, 01)+the execution result as the response message 609. The response message 609 is delivered to the requester 601 of the request source via the relay node-A 602.

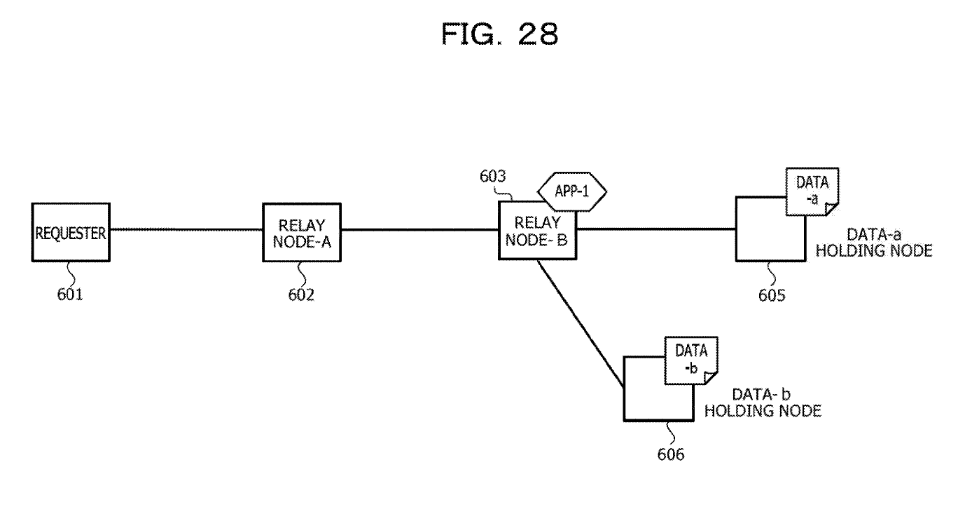

The network model used to describe the basic policy of FIG. 26 is configured to include five nodes (including the requester) via a network configuration in which the number of branch points is 1 and is the same tree structure of the network as that of FIG. 28. The requester 601 is located in advance on the network. As an initial state, App-1 is on the branch point node 610 on the network. Data-a and Data-b are disposed in leaf portions o the tree structure of the network as in FIG. 28. Therefore, to execute the application, the element objects are indispensable. The requester 601 issues an execution request for the application.

The tree structure of the network is mapped according to content of request content from an actual communication network. However, the application execution of a branch point node in the network operation according to the third embodiment can be applied even when the application execution is mapped to any complex tree structure.

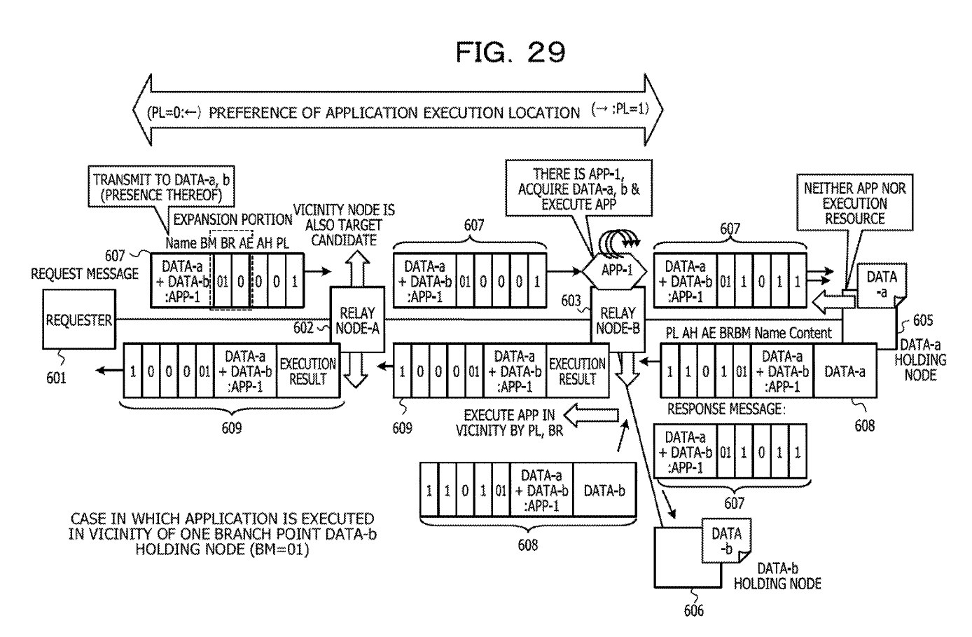

FIG. 29 illustrates the same network as that of FIG. 26 and an example of a network that has a general tree structure. This example indicates a case in which the number of pieces of dominant input data is 2 (Data-a and Data-b) and an application is executed at a branch point. In this case, PL=1and BM=01 are set in the request message 607. FIG. 29 illustrates the relay node-A 602 which has no application and the relay node-B 603 which has an application. The network operation of this case is as follows.

The requester 601 sets the PL bit and the BM bit of the request message 607 from the property of the application to be executed. In the example illustrated in FIG. 29, PL=1 (the application is executed in the vicinity of a destination node or a branch point) and BM=01 (the application is executed in the first branch point node 610F) are set. Here, the PL bit and the BM bit may be set by the relay node-A 602 corresponding to an edge node in FIG. 29.

A case of PL=1 in Part 1 of the example illustrated in FIG. 29 will be described. Here, a case of PL=0 (the application is executed in the vicinity of the requester 601) corresponds to the process procedure of the first embodiment.

In FIG. 29, destinations indicated by the name portion of the request message 607 in the requester 601 are a plurality of pieces of dominant input data and are Data-a and Data-b in this example. The requester transmits the request message that has the name portion.

In this example, Data-a and Data-b which are the destinations are connected by “+” and App-1 is connected by “.” in the name portion.

Since the request message 607 has the plurality of destinations, the relay node-B 603 which is the branch point node 610 transmits the same message to the plurality of network interfaces. At this time, when nodes (for example, the relay node-A 602 and the relay node-B 603) on a path from the requester 601 to Data-a and Data-b have a designated application (App-1) including nearby nodes, the AH bit is turned on. When there is an execution resource, the AE bit is turned on. Further, when the relay node-B 603 is the branch point node 610, the BR bit is set and the application execution is suppressed in subsequent nodes.

Each node on the path has information regarding the nearby nodes by searching for nearby nodes present within k hops from the self-node or inspecting the nearby nodes in advance.

In FIG. 29, the relay node-A 602 has neither the designated application nor the execution resource. Therefore, The AH and AE are not changed in the relay node-A 602 and remain to be 0. However, since the relay node-B 603 has no designation source, the relay node-B 603 sets the AH bit to 1 and relays the request message 607. Since the relay node-B 603 is the branch point node 610 (transmits the request message to the plurality of network interfaces), the BR bit is also set to 1.

The nodes (the Data-a holding node 605 and the Data-b holding node 606) having Data-a and Data-b which are the element objects which are the destinations operate as follows with reference to the header bits of the acquired request message 607.

Since the BR bit is turned on, designated data (Data-a or Data-b) is inserted into the content portion of the response message 608 to be returned irrespective of whether the self-node has the designated application or has the execution resource. In this case, the Data-a holding node 605 and the Data-b holding node 606 copy the header bits (PL, AH, AE, BR, and BM) of the request message 607 to the response message 608 without change.

The response message 608 of each of the Data-a holding node 605 and the Data-b holding node 606 is transmitted in the reverse path of the request message 607. Then, the response messages are combined into one message in the branch point node 610 (the relay node-B).

The nodes (for example, the relay node-A 602 and the relay node-B 603) on the path along which the response message 608 is received operate as follows.

In a case in which the self-node is not the branch point node 610 and the BR bit of the received response message is turned on, the response message 608 is transmitted without change in the reverse path to the request message 607 in the direction of the requester 601.

For example, in a case in which there are other node between the relay nodes (for example, the relay node-A 602 and the relay node-B 603) and the Data-a holding node 605, the relay nodes operate as follows. In a case in which the relay node is the branch point node 610, the relay node waits for arrival of all the response messages corresponding to the transmitted request message 607. When all the response messages arrive, all of the pieces of the input data indispensable to execute the application gather in the relay node. In a case in which the AE or AH of the response message is turned on and the relay node (including the vicinity) has the designated application or the execution resource, the relay node performs the application execution. Then, the result is inserted into the content portion of the response message to be returned. When the AH is not turned on and the AE is turned on in the relay node, a special application is acquired with another message and the application execution is performed. The relay node is assumed to store the fact that the AH or AE is turned on in the request message 607 and recognize the response message corresponding to the request message 607. The relay node performs the application execution and clears the AE, AH, and BR. In other cases, that is, in a case in which the application execution is not performed, content (for example, Data-a and Data-b) of the content portion of the received response message are inserted into one response message to be transmitted in the direction of the requester 601. At this time, the relay node clears the BR.

FIG. 29 corresponds to this case and the relay node-B 603 performs the application execution.

In a case in which the self-node is not a branch point and the BR bit of the response message is turned off (=a case in which the application is transmitted without being executed at a branch point and Data-a and Data-b are included in the response message), the relay node operates as follows. In a case in which the relay node returns on the AE or AH and the self-node (including the vicinity) has the designated application or the execution resource, the relay node performs the application execution and the result is inserted into the content portion of the response message to be returned. In a case in which the AH is not turned on and the AE is turned on in the relay node, a special application is acquired with another message and the application execution is performed. The relay node has the designated application or the execution resource in the closest vicinity of the branch point node 610. At this time, the relay node clears the AE, AH, and BR. In other cases, the received response message is transmitted without change in the direction of the requester 601.

In FIG. 29, the relay node-B 603 sets AH=1 and stores the setting. When the response messages arrive at the relay node-B 603 from the Data-a holding node 605 and the Data-b holding node 606, the relay node-B 603 has the application. Therefore, the application execution is performed in the relay node-B 603. Then, the result is inserted into the content portion of the response message to be returned in the relay node-B 603. At this time, the AH bit and the BR bit are cleared.

The application execution is performed in the following priority by performing the foregoing operation:

1. the branch point node 610;

2. the node closes to the branch point node 610 on the side of the requester 601 on the path; and

3. the node in the vicinity of the node close to the branch point node 610 on the path (the node which is not on the path and is within k hops from the node on the path).

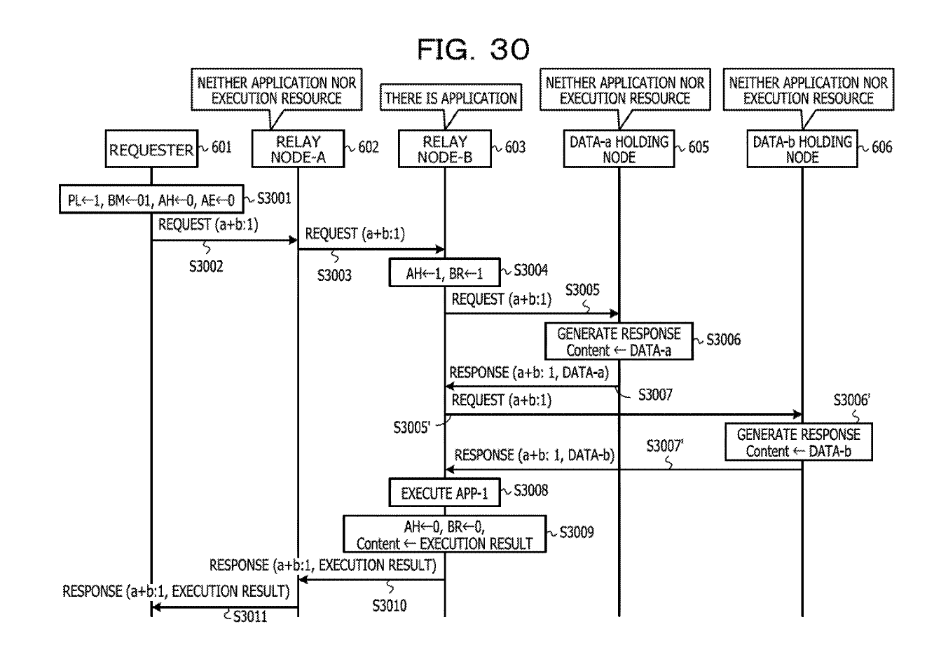

Next, description will be made with reference to a sequence diagram. FIG. 30 is a diagram illustrating a sequence of Part 1 of the example in FIG. 29.

The requester 601 sets PL=1, BM=01, AH=0, and AE=0 (S3001) and transmits the request message 607 in which “Data-a+Data-b: App-1” is set in the name portion to the relay node-A 602 (S3002). Since the relay node-A 602 has neither the application nor the execution resource, the relay node-A 602 transmits the request message 607 to the relay node-B 603 without changing the AH and AE (S3003). Since the relay node-B 603 has the application, the relay node-B 603 performs rewriting to AH=1 (S3004) and transmits the request message 607 to the Data-a holding node 605 and the Data-b holding node 606 (S3005 and S3005′). At this time, since the self-node is the branch point node 610, the BR bit of the request message 607 is turned on (S3004). The relay node-B 603 stores the rewriting to AH=1 in the request message 607 and the fact that the relay node-B 603 is the branch point node 610 (S3004).

The Data-a holding node 605 and the Data-b holding node 606 confirm that the BR in the request message 607 is 1 and generate the response message 608 (S3006 and S3006′). Then, the Data-a holding node 605 and the Data-b holding node 606 copy the values of the PL, AH, AE, BR, and BM of the request message 607 to the bits of the response message 608 (S3006 and S3006′). The Data-a holding node 605 and the Data-b holding node 606 insert the data (for example, Data-a or Data-b) which the self-node has into the content portion to the data and transmit the message to the relay node-B 603 (S3007 and S3007′).

Since the self-node is the branch point node 610, the relay node-B 603 waits for arrival of two response messages 608. The relay node-B 603 reads PL=1 and AH=1 in the response message 608. Then, since the self-node turns on the AH, the self-node has App-1, and thus determines to execute the application. Data-a and Data-b are included in the respectively received response messages 608. Therefore, the relay node-B 603 executes App-1 using the data (S3008). Then, AH=0 and BR=0 are set in the response message 608, an execution result is inserted into the content portion (the response message 609) (S3009), and the response message is transmitted to the relay node-A 602 (S3010).

The relay node-A 602 transmits the response message 609 to the requester 601 without change since AH=0 and AE=0 are set in the response message 609 (S3011).

The requester 601 receives the application execution result from the response message 609.

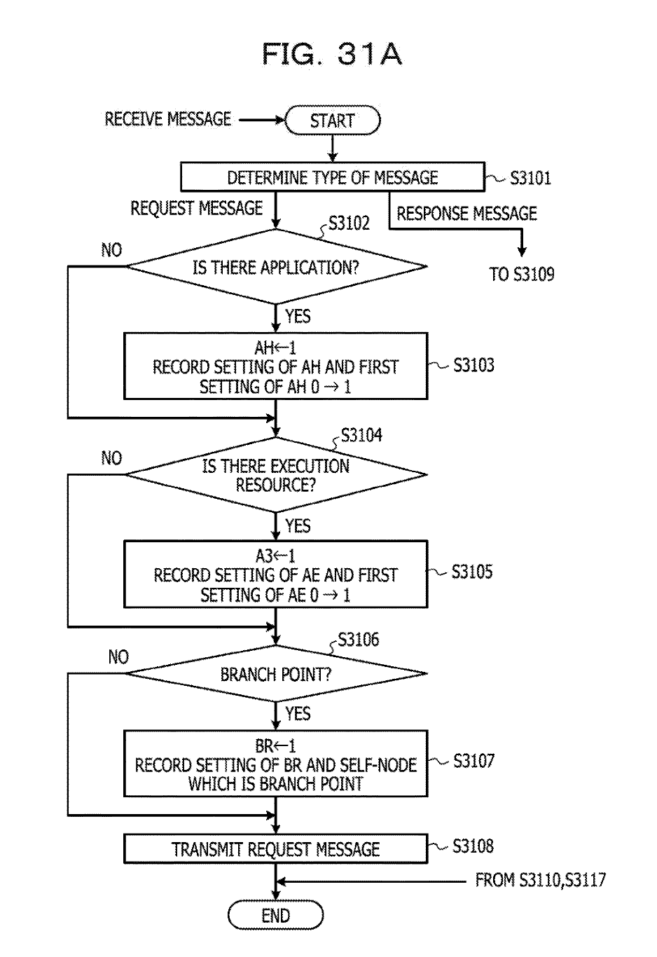

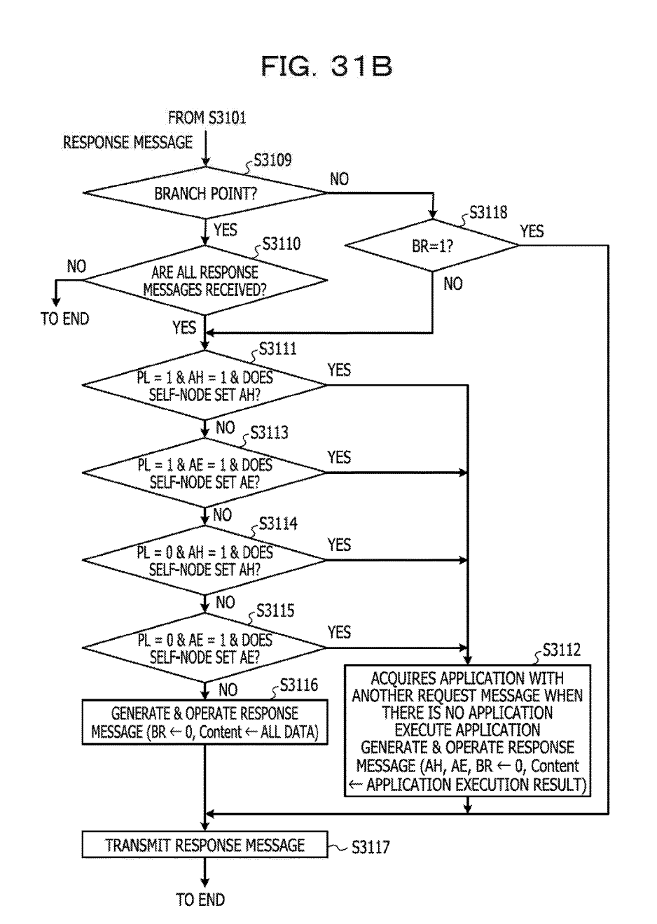

Next, the flow of a process of each node will be described. FIGS. 31A and 31B are diagrams illustrating the flow of a process of each node in Part 1 of the example. When a message is received, the node determines a type of message (separately performs definition of a header or the like and the determination) (S3101).

(Time of Request Message)

The node checks whether the self-node has an application designated in the name portion (S3102). When the node has the application (Yes in S3102), the node sets the AH of the request message to 1 (S3103). At this time, the node records the setting of the AH and whether to first set the AH of 0→1 (the AH of the received request message is 0 and whether the AH is rewritten to 1 by the self-node) (S3103).

Subsequently to S3103 or subsequently to a case in which the determination of S3102 is NO, the node checks whether the self-node has the execution resource (S3104). When the node has the execution resource (Yes in S3104), the node sets the AE of the request message to 1 (S3105). In this case, the node records the setting of the AE and whether to first set the AE of 0→1 (the AE of the received request message is 0 and whether the AE is rewritten to 1 by the self-node) (S3105).

Subsequently to S3105 or subsequently to a case in which the determination of S3104 is NO, the node checks whether the self-node is a branch point node (determines whether the request message is transmitted to the plurality of network interfaces based on the destination) (S3106). When the determination is YES (Yes in S3106), the node sets the BR of the request message to 1 (S3107). In this case, the node records the setting of the BR (the self-node is the branch point node) (S3107). Subsequently to S3107 or subsequently to a case in which the determination of S3106 is NO, the node transmits the request message to a subsequent node based on the destination (the object in the head of the name portion) (S3108).

(The time of the Request Message)

The node determines whether the self-node is a branch point node (S3109).

<The Time of the Branch Point Node>

The node determines whether to receive all the response messages (S3110). When the determination is NO, the process ends. When the determination is YES, the process proceeds to a subsequent process. The node checks (whether PL=1, AH=1, and the self-node sets the AH) (S3111). When the determination is YES, the node performs the application execution process (S3112). When the determination is NO, the node performs S3113. The node checks (whether PL=1, AE=1, and the self-node sets the AE) (S3113). When the determination is YES, the node performs the application execution process (S3112). When the determination is NO, S3114 is performed. The node checks (whether PL=0, AH=1, and the self-node first sets the AH) (S3114). When the determination is YES, the node performs the application execution process (S3112). When the determination is NO, S3115 is performed. The node checks (whether PL=0, AE=1, and the self-node first sets the AE) (S3115). When the determination is YES, the node performs the application execution process (S3112). When the determination is NO in all of S3111 to S3115, the node rests the BR to 0 without performing the application execution process and inserts all of the data into the content portion (S3116).

Application Execution Process: The node acquires the application with another request message when there is no application and executes the application (S3112). Further, the node resets the AH, AE, and BR to 0 in the response message and inserts the application execution result into the content portion (S3112).

The node transmits the response message to the node in the direction in which the corresponding request message is received (S3117).

<When Node is not Branch Point>

The node checks (the BR=1) (S3118). When the determination is YES, the node transmits the response message (S3117) and ends the process. When the determination is NO, S3111 is performed.

Next, a case of a network configuration in which the number of branch points is 2 according to Part 2 of the example of the third embodiment will be described.

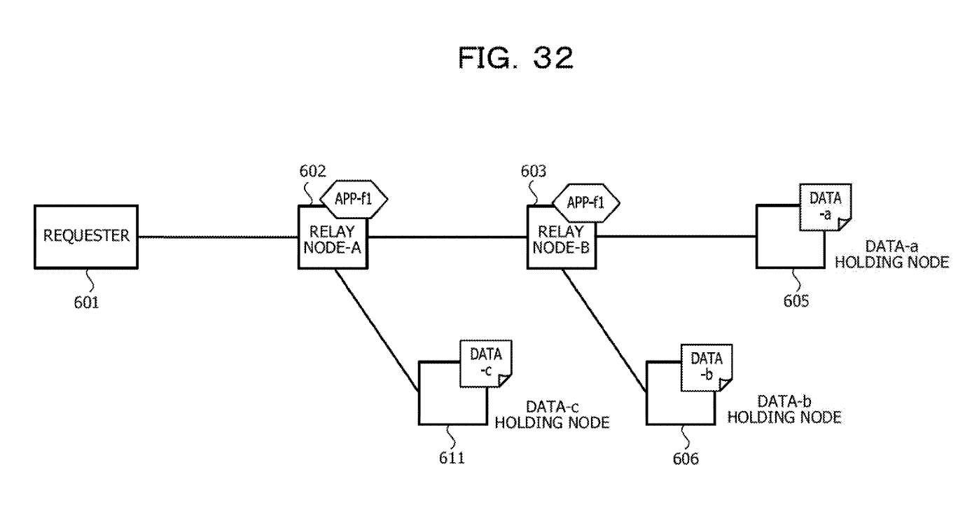

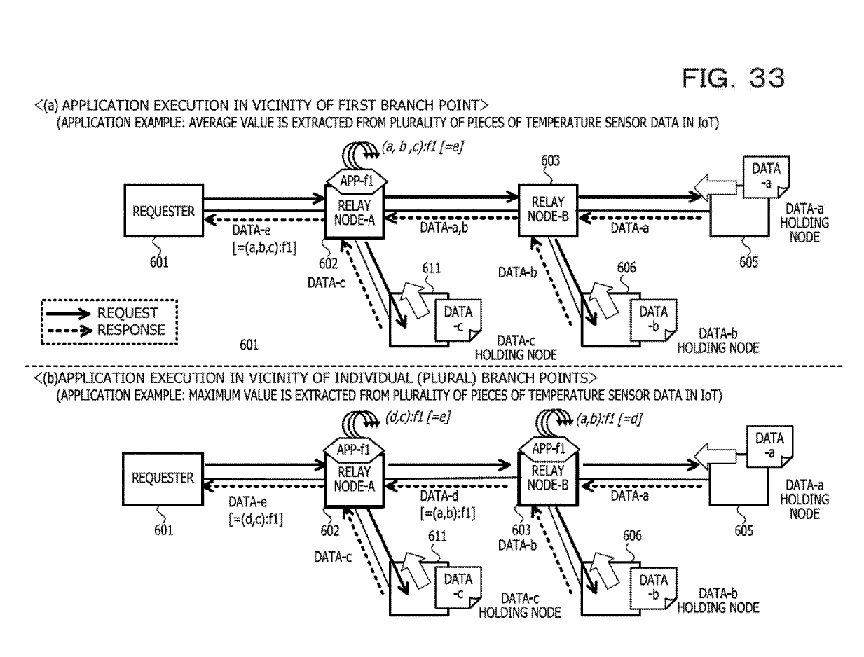

FIG. 32 is a diagram illustrating the configuration of a system to describe Part 2 of the example. The network includes six nodes (including the requester) and has a network exemplified in FIG. 32. As an initial state, Data-a, Data-b, Data-c, and App-f1 are disposed as in the drawing and these element objects are indispensable to execute the application (Data-a, Data-b, and Data-c are input and App-f1 is executed). The requester 601 issues an execution request of the application.

FIG. 33 is a diagram illustrating network operations of Part 2 of the example. Here, (a) indicates a case in which the application is executed in the vicinity of the first branch point. In addition, (b) indicates a case in which the application is executed in the vicinity of individual (plural) branch points. As the property of the application, the case indicated by (a) is a case in which the application may not be executed when all of the input data are not included and the case indicated by (b) is a case in which the application can be executed with some of the input data. In application examples, for example, (a) an average value is extracted from a plurality of pieces of temperature sensor data and (b) a maximum value is extracted from the plurality of pieces of temperature sensor data. The operation will be described below.

<(a) Case in Which Application is Executed at First Branch Point>

The requester 601 sets the PL bit and the BM bit of the request message 607 from the property of the application to be executed. As indicated in (a) of FIG. 33, here, PL=1 (the application execution in the vicinity of the destination node or the branch point) is set and BM=01 (the application execution at the first branch point) is set.

The requester 601 sets the destinations indicated by the name portion of the request message 607 as a plurality of pieces of dominant input data. Here, as indicated by (a) of FIG. 33, Data-a, Data-b, and Data-c are destinations. The requester 601 transmits the generated request message 607 to the path.

Since the relay node-A 602 has App-f1 and is the first branch point node 610F, AH=1 and BR=1 are set. The relay node-A 602 transmits the request message 607 set in this way to a Data-c holding node 611 and the relay node-B 603.

Since the relay node-B 603 is the branch point node 610 and the BR=1 is set in the request message 607, it is determined that the request message has already passed through the first branch point. Since BM=01 is set, the relay node-B 603 does not operate the BR and the request message 607 is transmitted to the Data-a holding node 605 and the Data-b holding node 606 without change.

The relay node-B 603 is the branch point node 610, but the self-node is not the first branch point node 610F. Therefore, at a time point at which all of the data returned from the Data-a and Data-b holding nodes are included, the relay node-B 603 returns the response message 608 into which the two pieces of data are inserted to the relay node-A 602. At this time, the BR is not operated (the BR=1 remains).

The relay node-A 602 executes App-f at a time point at which all of the data (Data-c, Data-a, and Data-b) from the Data-c holding node 611 and the relay node-B 603 are included. Then, the relay node-A 602 returns the response message 609 into which the result is inserted to the requester 601. At this time, the AH and BR are reset.

<(b) Case in Which Application is Executed in Vicinity of Individual (Plural) Branch Points>

The requester 601 sets the PL bit and the BM bit of the requester 607 from the property of the application to be executed. Here, as indicated by (b) of FIG. 33, PL=1 (the vicinity of the destination node or the branch point) is set and BM=10 (the execution at the individual branch points) is set.

The requester 601 generates the request message 607 in which the destinations indicated by the name portion of the request message 607 are set as a plurality of pieces of dominant input data (Data-a, Data-b, and Data-c in (b)) of FIG. 33 and transmits the message.

The relay node-A 602 has App-f1 and is the branch point node 610. Therefore, the relay node-A 602 sets AH=1 and BR=1 in the received request message 607. The request message 607 set in this way is transmitted to the Data-c holding node 611 and the relay node-B 602.

The relay node 603 has App-f1 and is the branch point node 610. Therefore, the relay node-B 603 sets AH=1 in the received request message 607 and transmits the set request message 607 to the Data-b holding node 606 and the Data-a holding node 605. At this time, since the BR is already set to 1, no operation is performed (the R=1 remains).

The relay node-B 603 is the branch point node 610 and the BM=10 is set. Therefore, at a time point at which all of the data returned from the Data-a and Data-b holding nodes are included, the relay node-B 603 executes App-f1 using the two pieces of data. The response message 609 into which the result is inserted is returned to the relay node-A 602. At this time, the AH is reset, but the relay node-B 603 is not the first branch point node 610F. Therefore, the BR is not operated (the BR=1 remains).

The relay node-A 602 executes App-f1 at a time point at which all of the data (a calculation result of Data-c, Data-a, and Data-b) from the Data-c holding node 611 and the relay node-B 603 are included.

Then, the relay node-A 602 returns a response message 609′ into which the result is inserted to the requester 601. In this case, the relay node-A 602 rests the AH and BR of the response message 609.

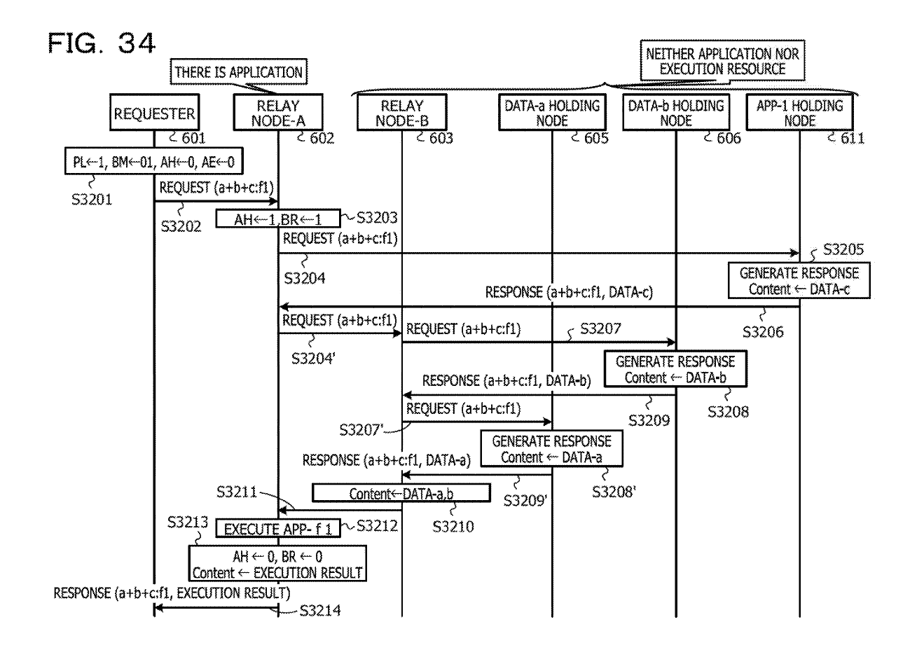

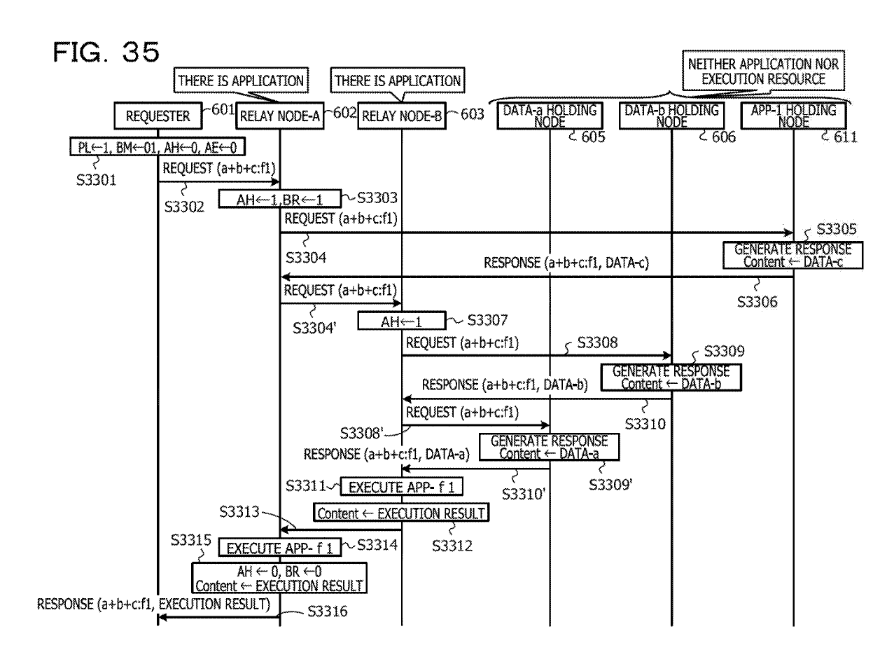

Next, a sequence of Part 2 of the example will be described. FIGS. 34 and 35 are diagrams illustrating the sequence of Part 2 of the example. The description will be made below.

FIG. 34 is a diagram illustrating a sequence of a network operation in a case in which the application execution is performed in the first branch point node 610F as in the case exemplified in Part 2(a) of the example. The requester 601 sets PL=1, BM=01, AH=0, and AE=0 and generates the request message 607 in which “Data-A+Data-b+Data-c: App-f1” is set in the name portion (S3201). Then, the requester 601 transmits the generated request message 607 to the relay node-A 602 (S3202).

Since the relay node-A 602 has the application, the relay node-A 602 performs rewriting to AH=1 in the received request message 607 (S3203). Then, the relay node-A 602 transmits the rewritten request message 607 to the Data-c holding node 611 and the relay node-B 603 (S3204 and S3204′). At this time, the relay node-A 602 turns on the BR bit of the request message 607 since the self-node is the first branch point node 610F (S3203). The relay node-A 602 stores the rewriting to the AH=1 in the request message 607 and the fact that the self-node is the first branch point node 610F.

The Data-c holding node 611 generates the response message 608 since the BR=1 is set in the received request message 607 (S3205). At this time, the Data-c holding node 611 copies the values of the PL, AH, AE, BR, and BM of the received request message 607 in the response message. Then, the Data-c holding node 611 inserts the data (Data-c) which the self-node has in the content portion (S3205). The Data-c holding node 611 transmits the response message 608 generated in this way to the relay node-A 602 (S3206).

The relay node-B 603 receiving the request message 607 in S3204′ is the branch point node 610, but confirms that the BR=1 and the BM=01 are already set in the request message 607. Therefore, the relay node-B 603 transmits the received request message 607 to the Data-b holding node 603 and the Data-a holding node 602 without changing the received request message 607 (S3207 and S3207′). At this time, the relay node-B 603 is the branch point node 610, but determines that the self-node is not the first branch point since the BR is already 1 and does not operate the BR (the BR=1 remains). The relay node-B 603 stores the fact that the self-node is not the first branch point node 610.

The Data-b holding node 606 and the Data-a holding node 605 confirm that the BR=1 is set in the received request message 607 and generate the response message 608 (S3208 and S3208′). At this time, the Data-b holding node 606 and the Data-a holding node 605 copy the values of the PL, AH, AE, BR, and BM of the request message 607 to the response message 608 (S3208 and S3208′). Then, the two nodes insert the data (Data-a or Data-b) which the self-node has in the content portion (S3208 and S3208′) and transmits the data to the relay node-B 603 (S3209 and S3209′).

The relay node-B 603 waits for arrival of the two response messages 608 (Data-a and Data-b). Then, at a time point at which the relay node-B 603 has Data-a and Data-b, the relay node-B 603 generates the response message 608 into which the two pieces of data are inserted since the self-node is the not the first branch point node 610 (S3210). Then, the relay node-B 603 transmits the generated response message 608 to the relay node-A 602 (S3211).

The relay node-A 602 waits for arrival of the two response messages 608 (Data-c, Data-a, and Data-b). The relay node-A 602 confirms that PL=1 and AH=1 are set in the received response message 608. Then, the relay node-A 602 determines that the self-node has App-1 and executes the application since the self-node is the first branch point node 610F and turns on the AH. Data-a, Data-b, and Data-c are all included in the received response message 608. Therefore, the relay node-A 602 executes App-1 using the data (S3212). Then, the relay node-A 602 updates the received response message 608 in which AH=0 and BR=0 are set to generate the response message 609 in which the execution result is inserted into the content portion (S3213). Then, the relay node-A 602 transmits the generated response message 609 to the requester 601 (S3214).

The requester 601 receives the application execution result by the response message 609 (S3214).

FIG. 35 is a diagram illustrating the sequence of Part 2(b) of the example. The requester 601 sets PL=1, BM=10, AH=0, and AE=0 and generates the request message 607 in which “Data-a+Data-b +Data-c: App-1” is set in the name portion (S3301). Subsequently, the requester 601 transmits the generated request message 607 to the relay node-A 602 (S3302).

Since the relay node-A 602 has the application, the relay node-A 602 performs rewriting to AH=1 (S3303). At this time, the relay node-A 602 turns on the BR bit of the request message 607 since the self-node is the first branch point node 610F (S3303). Then, the relay node-A 602 transmits the request message 607 rewritten in S3303 to the Data-c holding node 611 and the relay node-B 603 (S3304 and S3304′). The relay node-A 602 stores the rewriting to the AH=1 in the request message 607 and the fact that the self-node is the first branch point node 610F.

The Data-c holding node 611 confirms that the BR=1 is set in the received request message 607 and generates the response message 608 (S3305). At this time, the Data-c holding node 611 copies the values of the PL, AH, AE, BR, and BM of the received request message 607 in the response message 608. Then, the Data-c holding node 611 inserts the data (Data-c) which the self-node has in the content portion of the response message 608 (S3305) and transmits the response message 608 to the relay node-A 602 (S3306).

In S3304′, the relay node-B 603 receiving a request message 507 has the application, and therefore rewrites (overwrites) to AH=1 in the request message 507 (S3307). At this time, the relay node-B 603 is the branch point node 610, but determines that the self-node is not the first branch point node 610F since the BR is already 1 and does not operate the BR (the BR=1 remains). Subsequently to S3307, the relay node-B 603 transmits the rewritten request message 607 to the Data-b holding node 606 and the Data-a holding node 605 (S3308 and S3308′). The relay node-B 603 stores the rewriting to AH=1 in the request message 607 and the fact that the self-node is not the first branch point node 610F.

The Data-b holding node 606 and the Data-a holding node 605 confirm that the BR=1 is set in the received request message 607 and generate the response message 608 (S3309 and S3309′). The Data-b holding node 606 and the Data-a holding node 605 copy the value of the PL, AH, AE, BR, and BM of the request message 507 to the response message 608. The Data-b holding node 606 and the Data-a holding node 605 insert the data (Data-b or Data-a) which the self-node has in the content portion of the response message 608 (S3309 and S3309′). Next, the Data-b holding node 606 and the Data-a holding node 605 transmit the response message 608 generated by the self-node to the relay node-B 603 (S3310 and S3310′).

The relay node-B 603 waits for arrival of the two response messages 608 (Data-a and Data-b). The relay node-B 603 confirms that PL=1, AH=1, and BM=10 are set in the response message 608. The relay node-B 603 is not the first branch point node 610, but the self-node turns on the AH since the BM=10 is set. Since the self-node has App-1, the relay node-B 603 determines that the self-node executes the application.

Since Data-a and Data-b are included in the received response message 608, the relay node-B 603 executes App-1 using the data (53311). Then, the relay node-B 603 generates the response message 609 into which the execution result is inserted in the content portion of the response message 608 (S3312). Then, the relay node-B 603 transmits the generated response message 609 to the relay node-A 602 (S3313). At this time, the relay node-B 603 is not the first branch point node 610 and does not first set the AH from 0 to 1, the self-node transmits the response message in which the AH=1 remains (S3313).

The relay node-A 602 waits for arrival of the two response messages (a calculation result of Data-c, Data-a, and Data-b). The relay node-A 602 confirms that PL=1 and AH=1 are set in the response message. Then, the relay node-A 602 confirms that the self-node turns on the AH. Then, the relay node-A 602 confirms that the BM=10 is set. The relay node-A 602 stores the fact that the self-node is the first branch point node 610F and has App-1, and thus determines that the self-node executes the application. The calculation result of Data-c, Data-a, and Data-b is included in the received response messages 608 and 609. Therefore, the relay node-A 602 executes App-1 using the calculation result of the data (S3314). The relay node-A 602 updates any one of the received response messages 608 and 609 so that AH=0 and BR=0 are set and generates the response message 609′ into which the execution result is inserted in the content (S3315). Subsequently, the relay node-A 602 transmits the generated response message 609′ to the requester 601 (S3316).

The requester 601 receives the application execution result by the response message 609′ (S3316).

Through the network operation according to the third embodiment, it is possible to reduce transmission delay and an occupation bandwidth of the application or the data and it is possible to shorten a response time. It is possible to realize load sharing of the application execution process in the network and it is possible to achieve effective use of the execution resource.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication method executed by a communication system including a first node that requests to execute an application, a second node that stores data for executing the application, and a plurality of relay nodes coupled to a path between the first and second nodes, the communication method comprising:
determining, by the first node, a policy for selecting a node to execute the application from the plurality of relay nodes based on an amount of an output data which is an execution result of the application and an amount of an input data for executing the application;
transmitting a request message including identification information indicating the policy and requesting to execute the application via the path;
receiving, by a third node among the plurality of relay nodes, the request message;
acquiring the data from the second node, when it is determined that the third node is able to execute the application based on the identification information;
executing the application using at least the acquired data; and
transmitting a response message including the execution result of the application to the first node.

2. The communication method according to claim 1, further comprising:
transmitting, by the third node, the request message to a fourth node among the plurality of relay nodes when it is determined that the third node is not able to execute the application.

3. The communication method according to claim 1,
wherein the policy is one of a policy for selecting a node which is located within a predetermined number of hops from the first node or a policy for selecting a node which is located within the predetermined number of hops from the second node.

4. The communication method according to claim 3,
wherein the node which is located within the predetermined number of hops from the first node and the node which is located within the predetermined number of hops from the second node include a node which is not on the path.

5. The communication method according to claim 1, further comprising:
determining, by the third node, whether the application is executable based on at least one of a holding state of the application in the third node or a holding state of a resource with which the application is executable.

6. The communication method according to claim 5,
wherein the response message includes at least one of the holding state of the application in the third node or the holding state of the resource with which the application is executable.

7. The communication method according to claim 6,
wherein the resource is a hardware resource and a software environment in which the application is executable.

8. The communication method according to claim 5,
wherein the request message and the response message include branch point information indicating a plurality of branch points at which the path is branched.

9. The communication method according to claim 8,
wherein the deciding of the policy includes:
determining whether the application is executed by one node of the plurality of branch points based on a property of the application and the number of pieces of dominant input data when there are one or more branch points on the path and determining which node executes the application when the application is executed by one node of the plurality of branch points, and
storing a result of the determining as branch mode information in the request message, and
wherein the determining includes determining whether the application is executable based on the branch point information and the branch mode information.

10. The communication method according to claim 9,
wherein the determining of the policy includes setting the branch mode information according to a case in which there is no branch point, a case in which the application is executed by the node of a first branch point, and a case in which the application is shared and executed by each node of the plurality of branch points.

11. The communication method according to claim 1,
wherein the deciding of the policy includes:
storing setting information in which a type of application is associated with the policy in regard to a plurality of types of applications, and
extracting the policy associated with the type of application by accessing the setting information when the request message is transmitted.

12. The communication method according to claim 1,
wherein the transmitting of the request message includes:
specifying one or more pieces of data with a maximum size among a plurality of pieces of data requisite for the application execution, and
setting one or more nodes storing the specified one or more pieces of data as destinations of the request message among the plurality of relay nodes and the second node.

13. A communication system comprising:
a first node configured to request to execute an application;
a second node configured that stores data for executing the application; and
a plurality of relay nodes coupled to a path between the first and second nodes,
wherein the first node is configured to:
determine a policy for selecting a node to execute the application from the plurality of relay nodes based on an amount of an output data which is an execution result of the application and an amount of an input data for executing the application, and
transmit a request message including identification information indicating the policy and requesting to execute the application via the path, and
wherein a third node among the plurality of relay nodes is configured to:
receive the request message,
acquire the data from the second node, when it is determined that the third node is able to execute the application based on the identification information,
execute the application using at least the acquired data, and
transmit a response message including the execution result of the application to the first node.

14. A communication apparatus comprising:
a memory; and
a processor coupled to the memory and configured to:
determine a policy for selecting a node to execute the application from a plurality of relay nodes coupled to a path between the communication apparatus and another communication apparatus storing data for executing application based on an amount of an output data which is an execution result of the application and an amount of an input data for executing the application,
transmit a request message including identification information indicating the policy and requesting to execute the application via the path, and
acquire the data from the another communication apparatus from a relay node determined to be able to execute the application based on the identification information among the plurality of relay nodes, and
receive a response message including an execution result of the application obtained by executing the application using at least the acquired data.
